(19) United States
(12) Patent Application Publication
(10) Pub. No.: US 2024/0354654 A1
(43) Pub. Date: Oct. 24, 2024

(54) ARTIFICIAL INTELLIGENCE/MACHINE LEARNING TRAINING SERVICES IN NON-REAL TIME RADIO ACCESS NETWORK INTELLIGENT CONTROLLER

(71) Applicant: Intel Corporation, Santa Clara, CA (US)

(72) Inventors: Dawei Ying, Portland, OR (US); Jaemin Han, Portland, OR (US); Leifeng Ruan, Beijing (CN); Hui Ma, Kanata (CA); Qian Li, Beaverton, OR (US)

(73) Assignee: Intel Corporation, Santa Clara, CA (US)

(21) Appl. No.: 18/652,374

(22) Filed: May 1, 2024

Related U.S. Application Data
(60) Provisional application No. 63/499,422, filed on May 1, 2023.

(51) Int. Cl. G06N 20/00; H04L 41/16

(52) U.S. Cl. CPC G06N 20/00; H04L 41/16

(57) ABSTRACT

A machine-readable storage medium, an apparatus and a method, each corresponding to either a service consumer or a service producer of a non-real-time (non-RT) radio access network intelligent controller (RIC) of a Service Management and Orchestration Framework (SMO FW). Communications from the service consumer to the service producer include: a training request for artificial intelligence/machine learning (AI/ML) training job; a query regarding a training status of the AI/ML training job; a cancel training request to cancel the AI/ML training job; and a notification regarding the training status of the AI/ML training job.

### CROSS REFERENCE TO RELATED APPLICATIONS

This application claims the benefit of and priority from U.S. Provisional Patent Application No. 63/499,422 entitled “AI/ML TRAINING SERVICES IN NON-REAL TIME RADIO ACCESS NETWORK INTELLIGENT CONTROLLER,” filed May 1, 2023, the entire disclosure of which is incorporated herein by reference.

### BACKGROUND

Various embodiments generally relate to the field of cellular communications, and particularly to concepts an architecture frameworks related to the Open Radio Access Network (ORAN).

### BRIEF DESCRIPTION OF THE DRAWINGS

FIG. 1 illustrates a Non real time (Non-RT) radio access network intelligent controller (RIC) (Non-RT RIC) architecture as supported in Open Radio Access Network's Working Group 2 (O-RAN.WG2).

FIG. 2 illustrates an end-to-end (E2E) sequence diagram of a training service consumer Non-RT RIC application (rApp) requesting training of an Artificial Intelligence/Machine Learning (AI/ML) model according to some embodiments.

FIG. 3 illustrates the parts of end-to-end (E2E) sequence diagram of FIG. 2 that relate to the training service consumer rApp requesting training of an AI/ML model according to some embodiments.

FIG. 4 illustrates a diagram of API operations relating to requesting training according to some embodiments.

FIG. 5 illustrates the parts of end-to-end (E2E) sequence diagram of FIG. 2 that relate to the training service consumer rApp querying AI/ML model for training status according to some embodiments.

FIG. 6 illustrates a diagram of API operations relating to querying training job status according to some embodiments according to some embodiments.

FIG. 7 illustrates parts 700 of end-to-end (E2E) sequence diagram 200 of FIG. 2 that relate to the training service consumer rApp requesting to cancel training of an AI/ML model according to some embodiments.

FIG. 8 illustrates a diagram of application programming interface (API operations relating to cancelling training according to some embodiments.

FIG. 9 illustrates the parts of end-to-end (E2E) sequence diagram of FIG. 2 that relate to the training service consumer rApp being notified of training status of training of an AI/ML model according to some embodiments.

FIG. 10 illustrates a diagram of API operations which the API producer uses to notify the training status to the API consumer

FIG. 11 illustrates a resource uniform resource identifier (URI) structure for an API training according to a first embodiment.

FIG. 12 illustrates a resource uniform resource identifier (URI) structure for an API training according to a second embodiment.

FIG. 13 illustrates a network that is to operate in a manner consistent with Third Generation Partnership Project (3GPP) technical specifications for Long Term Evolution (LTE) or Fifth Generation/New Radio (5G/NR) systems.

FIG. 14 illustrates a wireless network in accordance with various embodiments.

FIG. 15 illustrates a block diagram of components, according to some example embodiments, able to read instructions from a machine-readable or computer-readable medium (e.g., a non-transitory machine-readable storage medium).

FIG. 16 illustrates a high-level view of an Open RAN (O-RAN) architecture, comparable in some aspects to that of the architecture of FIG. 1.

FIG. 17 illustrates an O-RAN logical architecture corresponding to the O-RAN architecture of FIG. 16.

FIG. 18 illustrates a wireless network to operate in a matter consistent with 3GPP technical specifications or technical reports for 6G systems.

FIG. 19 illustrates a simplified block diagram of artificial (AI)-assisted communication between a User Equipment (UE) and a Radio Access Network (RAN).

FIG. 20 illustrates a method according to a first embodiment.

FIG. 21 illustrates a method according to a second embodiment.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Open radio access network (O-RAN) is working on inserting artificial intelligence (AI) and machine learning (ML) into wireless communication network by introducing non real-time (Non-RT) and near real-time (Near-RT) RAN intelligent controller (RIC), as set forth for example in O-RAN Working Group 1 (WG1)'S “O-RAN Architecture Description”. Third party applications can be deployed into a Non-RT RIC to provide added value services, and such Non-RT RIC applications are called “rApps”. Various embodiments herein provide techniques for AI/ML training services in a Non-RT RIC and related use cases, procedures, operations, and in designs involving application programming interfaces (APIs) that conform to the principles of the representational state transfer (REST) architectural style (RESTful API designs).

Various embodiments herein provide techniques for Artificial Intelligence (AI)/Machine Learning (ML) training services in the Non-RT RIC. The present disclosure presents use cases, procedures, operations, and RESTful API designs for the above-mentioned services.

Detailed AI/ML training services in Non-RT RIC are not specified yet in O-RAN Working Group (WG) 2.

### A. Brief Description of Non-RT RIC Functional Architecture and AI/ML Workflow Services

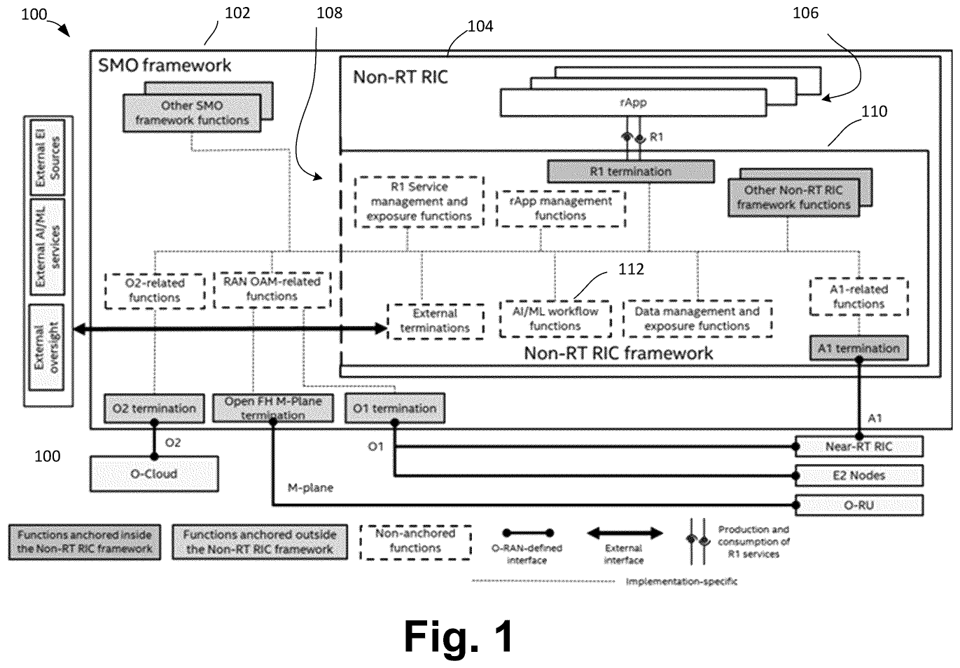

FIG. 1 a Non-RT RIC architecture 100, for example as supported in O-RAN.WG2.Non-RT-RIC-ARCH-TS-v03.00. In O-RAN, Non-RT RIC is to provide policy-based guidance and enrichment information to Near-RT RIC for intelligent RAN optimization and operation. As shown in FIG. 1, the Non-RT RIC architecture 100 includes a service management and orchestration (SMO) framework 102 that encompasses Non-RT RIC 104. The Non-RT RIC 104 is a functional entity that is to provide configurations for operation of an O-RAN system, and is shown as including a first layer 106 to host rApps, and a second layer 110 that encompasses the Non-RT RIC's Non-RT RIC framework (FW) 108. The rApps may include any applications or services such as from third party vendors, and the Non-RT RIC 104 provides support for the implementation of such applications and services in a manner that is vendor agnostic. One or more rApps can for example provide AI/ML training services. Training services may further be provided through the SMO FW 102 in general. The Non-RT RIC FWK 108 encompasses functional entities such as R1 termination, A1 termination, and Other Non-RT RIC framework functions as anchored functional entities (deemed part of the Non-RT RIC 104. The Non-RT RIC FWK 108 encompasses functional entities that are non-anchored (as shown in blocks bordered by broken lines within layer 108), such as, for example, rApp management functions, External terminations, and AI/ML workflow functions 112. The non-anchored functional entities shown in the Non-RT RIC 104 may optionally be hosted, outside of the Non-RT RIC FWK 108 within the SMO FW 102. The AI/ML workflow functions 112 in the Non-RT RIC framework can produce AI/ML-related services.

In the current Non-RT RIC architecture as set forth in O-RAN.WG2.Non-RT-RIC-ARCH-TS-v03.00, the following AI/ML workflow services have been defined:
AI/ML training services, which allow an AI/ML training service consumer to request training of an AI/ML model by specifying the training requirements (e.g.; required data, model, validation criteria, etc); AI/ML training services can be produced by the SMO/Non-RT RIC framework or by rApps;
AI/ML model management and exposure services, where services are produced by the SMO/Non-RT RIC framework and can enable:
   AI/ML model registration/deregistration, which allows an rApp to register, update the registration of, and deregister the AI/ML model that it provides; An rApp needs to be authorised to register, update the registration of, or deregister the AI/ML model it provides;
   AI/ML model discovery, which allows an rApp to discover registered AI/ML model(s) based on its selection criteria if it is provided; An rApp needs to be authorised to discover registered AI/ML models;
   AI/ML model change subscription, which allows an rApp to subscribe to and receive notifications of changes of a registered AI/ML model;
   AI/ML model storage, which allows an rApp to request the storage of an AI/ML model it registered and the AI/ML model associated information; and
   AI/ML model training capability registration/deregistration (an optional service), which allows an AI/ML training service producer to register/update/deregister its capability of training an AI/ML model; and
AI/ML model performance monitoring services, which allow an authorised AI/ML performance monitoring service consumer to request monitoring the performance of a deployed AI/ML model.

However, detailed use cases, procedures, service operations, and API designs have not been defined.

In related published international patent application WO2022060923A1 (“WO923”) by the same applicant as that of the instant application, AI/ML-related services (e.g., model training, model repository, and model management) in Non-RT RIC have been described. Also described were AI/ML training services produced by rApps.

Embodiments herein may update and complement the previously described techniques. Further, embodiments may relate to AI/ML model management and exposure (AIMME) services.

### B. AI/ML Training Services-Introduction

In WG2, it has been agreed that the AI/ML training services can be produced by the Non-RT RIC FW as one alternative, or by rApp as another alternative. Aspects of various embodiments herein may include the following four service operations:
1. Request training (create training job)
2. Query training status
3. Cancel training (stop training job)
4. Notify training status

### C. Overall End-to-End (E2E) Sequence Diagram

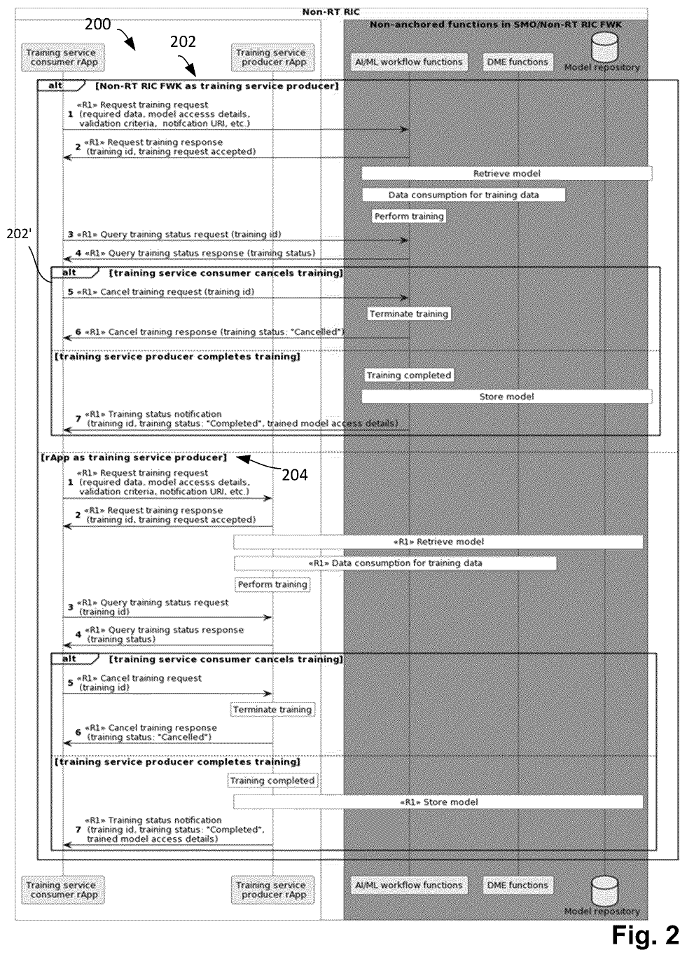

FIG. 2 illustrates an end-to-end (E2E) sequence diagram 200 of a training service consumer rApp requesting training of an AI/ML model according to some embodiments, with the following two alternatives: (a) where the training service producer corresponds to the AI/ML workflow functions 112 of the non-RT RIC FWK 108 of FIG. 1 as shown at 202 in FIG. 2; and (b) where the training service provider is an rApp as shown at 204 in FIG. 2.

### (a) Alternative 1: The Training Service Producer is the AI/ML Workflow Functions in the Non-RT RIC FW.

Referring to FIG. 2, under alternative 1 as indicated by reference numeral 202, the training service consumer rApp may, at operation 1, send training request to the AI/ML workflow functions of the Non-RT RIC FW. The training request may include but not be limited to the following information:
information about the required training data;
model access details allowing the AI/ML workflow functions to retrieve the model to be trained from the model repository;
optionally, information about training criteria, e.g., verification criteria;
optionally, maximum number of epochs or maximum training time;
call-back URI to receive training status notifications.

If the training request is accepted by the AI/ML workflow functions, it assigns the training request an identifier for the training job, and sends, at operation 2, the training job identifier to the training consumer rApp, indicating the training request is accepted. If the training request is not accepted by the AI/ML workflow functions, the response may include the proper error indications and optionally, error causes (e.g., lack of computing resources, etc.)

Based on the model access details, the AI/ML workflow functions can retrieve the model to be trained. Based on the training data information, the AI/ML workflow functions can request/subscribe training data via the data management and exposure (DME) functions. After obtaining the model and training data, the AI/ML workflow functions can start and perform the model training.

The training consumer rApp can query, at operation 3, the training status by sending a query request to the AI/ML workflow functions. The query request can include (but not be limited to) the training job id. In the query response at operation 4, the AI/ML workflow functions provide the current status of the queried training job. Possible status can include but not limited to
completed, indicating the training is successfully completed;
in-progress, indicating the training is not completed and it is ongoing;
on-hold, indicating the training is not completed and it is on hold by the training service producer;
aborted, indicating the training job is stopped by the training service producer;
time-out, indicating the training job is completed (e.g., reaching the maximum epochs) but failed to meet the training criteria;
cancelled, indicating the training job is stopped by the training service consumer.

If the training service consumer rApp decides to cancel the training job as indicated at reference numeral 202′, it can send a request, at operation 5, to the AI/ML workflow functions. The request can include (but not be limited to) the training job id. The AI/ML workflow functions terminate the training and send response, at operation 6, to the training service consumer rApp, including the status of “Cancelled”, confirming the termination of the training.

If the training is completed however, the AI/ML workflow functions can store the trained model in the model repository, and at operation 7, send training status notification to the training service consumer rApp, including but not limited to the following information:
training job id;
training status (e.g., “Completed”, if the training is successful);
trained model access details allowing the training service consumer rApp to retrieve the trained model from the model repository.
   (b) Alternative 2: The Training Service Producer is Another rApp

Referring still to FIG. 2, under alternative 2 as indicated by reference numeral 204, most the steps in this alternative are the same as the previous alternative 1 described above, with the difference being that the training service producer has changed from the AI/ML workflow functions in the Non-RT RIC FW to another rApp (as in an rApp different from the service consumer rApp). Differences may include:
the training service producer rApp may retrieve and store the model via the R1 interface;
the training service producer rApp may consume training data via the R1 interface.

Note that before requesting AI/ML training at operation 1, the training service consumer may discover the training service producer via the service management and exposure (SME) services.

At items D, E, F and G below, the operations, according to some embodiments, of requesting training, querying the training status, cancelling the training, and notifying training status will be described, respectively.

### D. Request Training (Create Training Job)

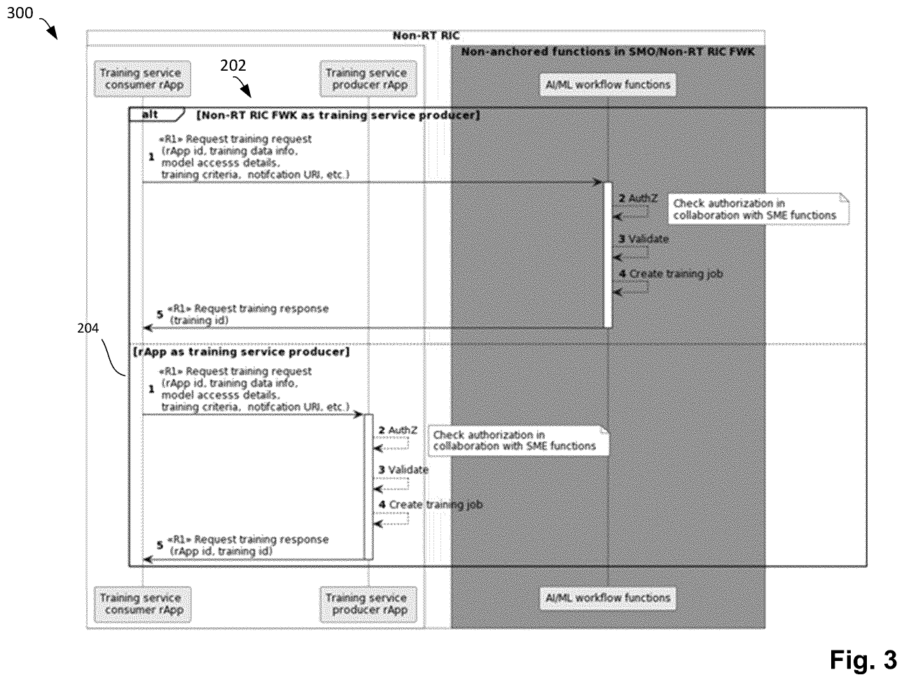

Let us now refer to FIG. 3, which shows the parts 300 of end-to-end (E2E) sequence diagram 200 of FIG. 2 that relate to the training service consumer rApp requesting training of an AI/ML model with the following two alternatives: (a) where the training service producer corresponds to the AI/ML workflow functions 112 of the non-RT RIC FWK 108 of FIG. 1 as shown at 202 in FIGS. 2 and 3; and (b) where the training service provider is an rApp as shown at 204 in FIGS. 2 and 3.

### D.1. R1 Use Case

This use case allows a training service consumer rApp to request training of an AI/ML model, as referred to in FIGS. 2 and 3 by reference numeral 202. Table 1 below shows use case stages versus and proposals for evolution of the O-RAN specification per use case stage according to some embodiments for the operation of requesting AI/ML training.

TABLE 1

| Use Case | |
|---|---|
| Stage | Evolution/Specification |
| Goal | The training service consumer rApp requests training of an |
| | AI/ML model. |
| Actors and | Training service consumer rApp in the role of Service |
| Roles | Consumer. |
| | In alternative 1, the AI/ML workflow functions in the role |
| | of Service Producer. |
| | In alternative 2, the training service producer rApp in the |
| | role of the Service Producer. |
| Assumptions | n/a |
| Pre- | The training service consumer rApp is deployed, |
| conditions | authenticated, and authorized to consume training |
| | services. |
| | The training service producer rApp is deployed, |
| | authenticated, and authorized to produce training |
| | services. |
| Begins when | The training service consumer rApp determines the need to |
| | train an AI/ML model |
| Step 1 (M) | The training service consumer rApp requests the training |
| | service producer to train an AI/ML model providing |
| | rAppId, information about training data, model access |
| | details, training criteria, notification URI, etc. |
| Step 2 (M) | The training service producer checks with SME functions |
| | whether the training service consumer rApp is authorized to |
| | request training |
| Step 3 (M) | The training service producer validates the request |
| Step 4 (M) | The training service producer create the training job |
| Step 5 (M) | The training service producer responds to the training |
| | service consumer rApp with training job identifier as a |
| | parameter. |
| Ends when | The training service consumer rApp is able to create the |
| | training job at the training service producer |
| Exceptions | n/a |
| Post | The training service producer can retrieve trained model |
| Conditions | from model repository and consume training data from |
| | DME. |
| Traceability | n/a |

### D.2. Service Operation

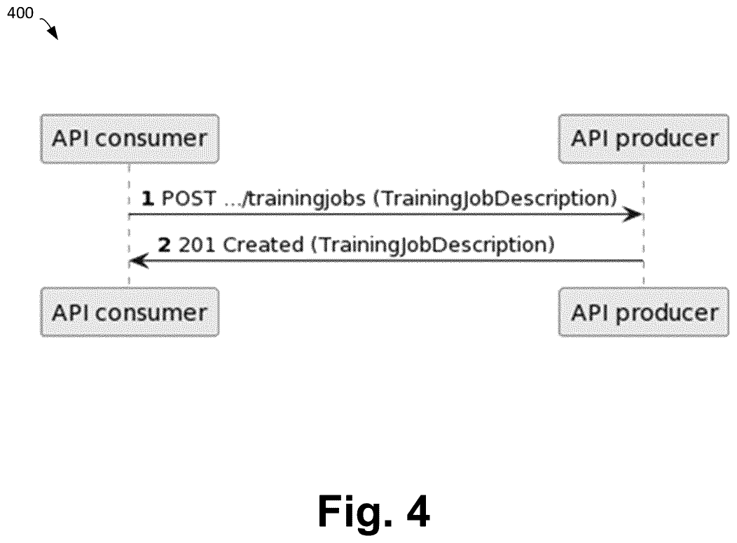

Let us now refer to FIG. 4, which shows a diagram 400 of API operations relating to requesting training according to some embodiments. The API consumer may use the shown operation to request training (create a training job) for an AI/ML model. The operation is based on HyperText Transfer Protocol (HTTP) POST, POST referring to methods defined by the HTTP protocol for sending data to a server to create or update a resource.

The service operation may be as follows:
1) the API consumer shall send an HTTP POST request to the API producer that includes the training job description describing the training request. The API producer shall process the message body received in the HTTP POST message and determine if the training request from the API consumer can be accepted or not;
2) the API producer shall generate the training job identifier and construct the URI for the created training job. The API producer shall return the HTTP POST response. On success, “ration Created” shall be returned. The message body shall carrier the created training job description, and the “Location” HTTP header shall be presented and shall carry the URI for the created training job, identified by the training job identifier. On failure, appropriate error code shall be returned, and the message response body may contain additional error information.

### E. Query Training Status

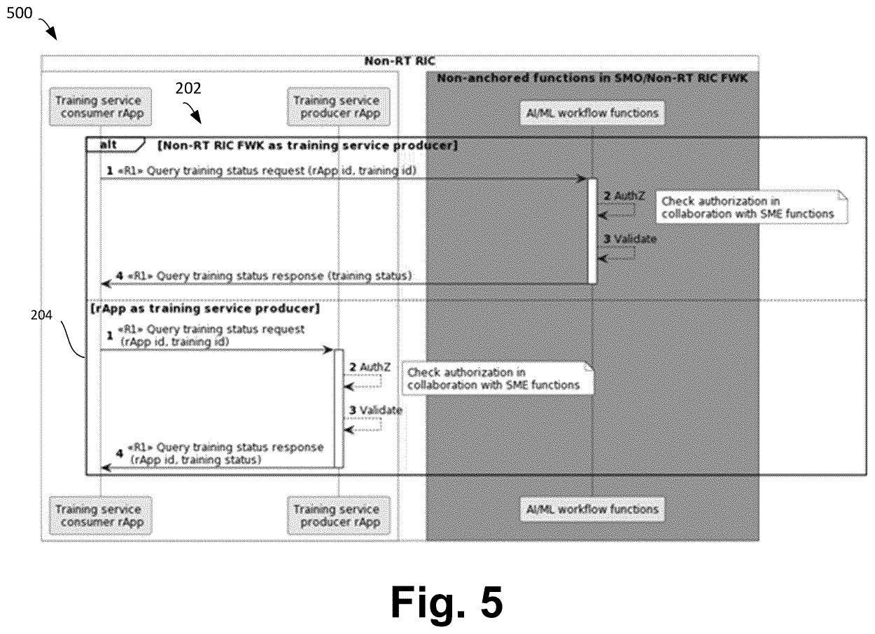

Let us now refer to FIG. 5, which shows the parts 500 of end-to-end (E2E) sequence diagram 200 of FIG. 2 that relate to the training service consumer rApp querying AI/ML model for training status with the following two alternatives: (a) where the training service producer corresponds to the AI/ML workflow functions 112 of the non-RT RIC FWK 108 of FIG. 1 as shown at 202 in FIGS. 2 and 5; and (b) where the training service provider is an rApp as shown at 204 in FIGS. 2 and 5.

### E.1. R1 Use Case

This use case allows a training service consumer rApp to query training status of a created training job.

Table 2 below shows use case stages versus and proposals for evolution of the O-RAN specification per use case stage according to some embodiments for the operation of querying training status.

TABLE 2

| Use Case | |
|---|---|
| Stage | Evolution/Specification |
| Goal | The training service consumer rApp query training status |
| | of a created training job. |
| Actors and | Training service consumer rApp in the role of Service |
| Roles | Consumer. |
| | In alternative 1, the AI/ML workflow functions in the role |
| | of Service Producer. |
| | In alternative 2, the training service producer rApp in the |
| | role of the Service Producer. |
| Assumptions | n/a |
| Pre- | The training service consumer rApp is deployed, |
| conditions | authenticated, and authorized to consume training |
| | services. |
| | The training service producer rApp is deployed, |
| | authenticated, and authorized to produce training |
| | services. |
| Begins when | The training service consumer rApp determines the need to |
| | query the training status |
| Step 1 (M) | The training service consumer rApp queries the training |
| | service producer about the status of a created training job |
| | by providing rAppId and training job identifier. |
| Step 2 (M) | The training service producer checks with SME functions |
| | whether the training service consumer rApp is authorized to |
| | query the training status |
| Step 3 (M) | The training service producer validates the request |
| Step 4 (M) | The training service producer responds to the training |
| | service consumer rApp with training status. |
| Ends when | The training service consumer rApp is able to obtain the |
| | training status. |
| Exceptions | n/a |
| Post | The training status is known to the training service |
| Conditions | consumer rApp. |
| Traceability | n/a |

### E.2. Service Operation

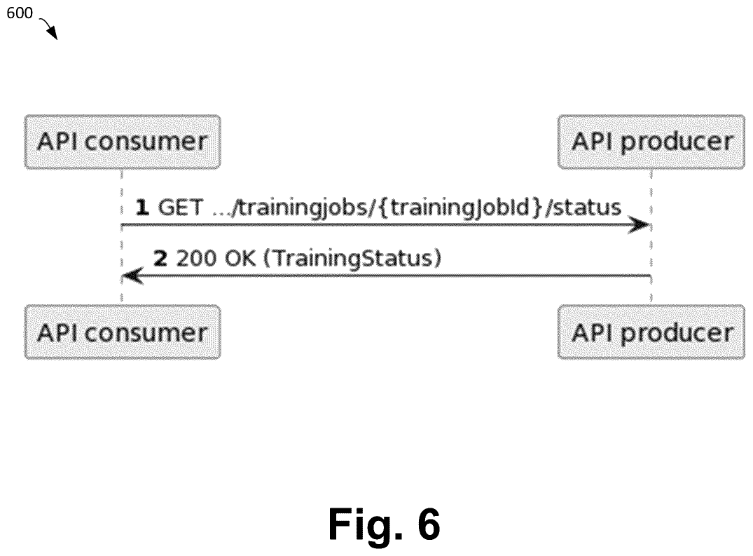

Let us now refer to FIG. 6, which shows a diagram 600 of API operations relating to querying training job status according to some embodiments. The API consumer may use this operation to query the training status of a created training job. The operation is based on HTTP GET, where GET refers to a method defined by the HTTP protocol to request retrieval of data.

The service operation may be as follows:
1) the API consumer shall send an HTTP GET request to the API producer. The target URI shall identify the training job being queried and the message body shall be empty;
2) the API producer shall return the HTTP GET response. On success, “200 OK” shall be returned. The message body shall carrier the training status of the training job identified by the training job identifier. On failure, appropriate error code shall be returned, and the message response body may contain additional error information.

### F. Cancel Training (Stop Training Job)

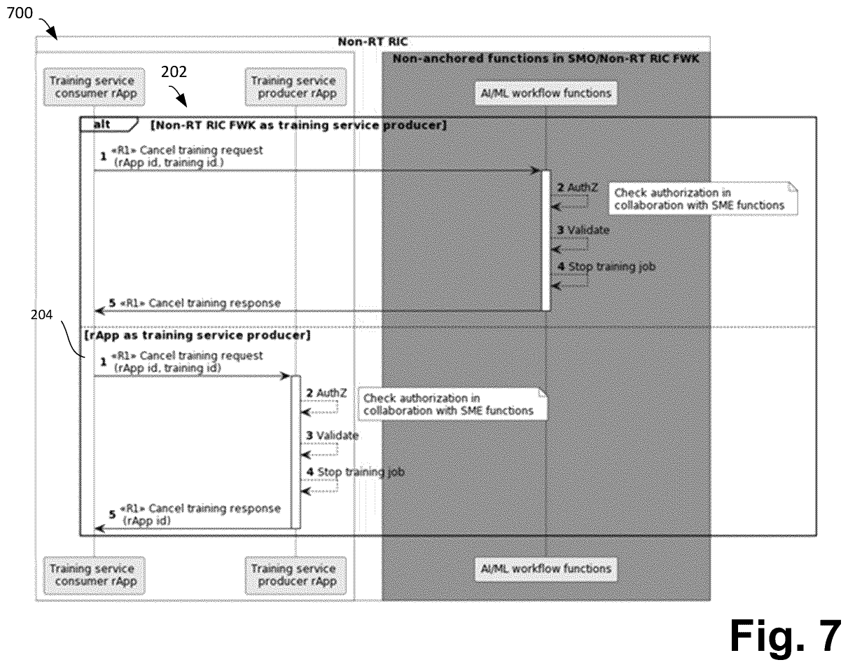

Let us now refer to FIG. 7, which shows the parts 700 of end-to-end (E2E) sequence diagram 200 of FIG. 2 that relate to the training service consumer rApp requesting to cancel training of an AI/ML model with the following two alternatives: (a) where the training service producer corresponds to the AI/ML workflow functions 112 of the non-RT RIC FWK 108 of FIG. 1 as shown at 202 in FIGS. 2 and 3; and (b) where the training service provider is an rApp as shown at 204 in FIGS. 2 and 3.

### F.1. R1 Use Case

This use case allows a training service consumer rApp to request training of an AI/ML model, as referred to in FIGS. 2 and 7 by reference numeral 202. Table 3 below shows use case stages versus and proposals for evolution of the O-RAN specification per use case stage. according to some embodiments for the operation of cancelling AI/ML training.

TABLE 3

| Use Case | |
|---|---|
| Stage | Evolution/Specification |
| Goal | The training service consumer rApp cancels training of an |
| | AI/ML model. |
| Actors and | Training service consumer rApp in the role of Service |
| Roles | Consumer. |
| | In alternative 1, the AI/ML workflow functions in the role |
| | of Service Producer. |
| | In alternative 2, the training service producer rApp in the |
| | role of the Service Producer. |
| Assumptions | n/a |
| Pre- | The training service consumer rApp is deployed, |
| conditions | authenticated, and authorized to consume training |
| | services. |
| | The training service producer rApp is deployed, |
| | authenticated, and authorized to produce training |
| | services. |
| Begins when | The training service consumer rApp determines to cancel |
| | the training of an AI/ML model |
| Step 1 (M) | The training service consumer rApp cancels the training job |
| | providing rAppId and training job identifier. |
| Step 2 (M) | The training service producer checks with SME functions |
| | whether the training service consumer rApp is authorized to |
| | cancel the training |
| Step 3 (M) | The training service producer validates the request |
| Step 4 (M) | The training service producer stops the training job |
| Step 5 (M) | The training service producer responds to the training |
| | service consumer rApp. |
| Ends when | The training service producer was able to cancel training of |
| | an AI/ML model. |
| Exceptions | n/a |
| Post | The training job is cancelled. |
| Conditions | |
| Traceability | n/a |

### F.2. Service Operation

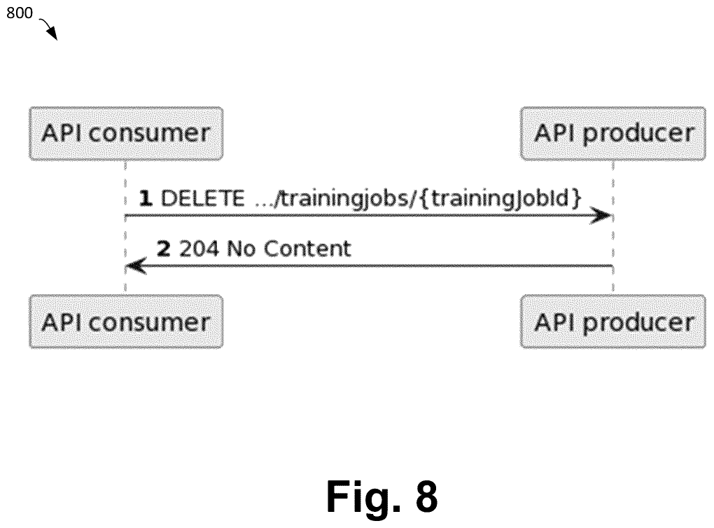

Let us now refer to FIG. 8, which shows a diagram 800 of API operations relating to cancelling training according to some embodiments. The API consumer may use the shown operation to cancel training for an AI/ML model. The operation is based on HyperText Transfer Protocol (HTTP) DELETE, DELETE referring to methods defined by the HTTP protocol for deleting a specified resource.

The service operation may be as follows:
1) the API consumer shall send an HTTP DELETE request to the API producer. The target URI shall identify the training job to be cancelled and the message body shall be empty;
2) the API producer shall return the HTTP DELETE response. On success, “204 No Content” shall be returned. The message body shall be empty. On failure, appropriate error code shall be returned, and the message response body may contain additional error information.

### G. Notify Training Status

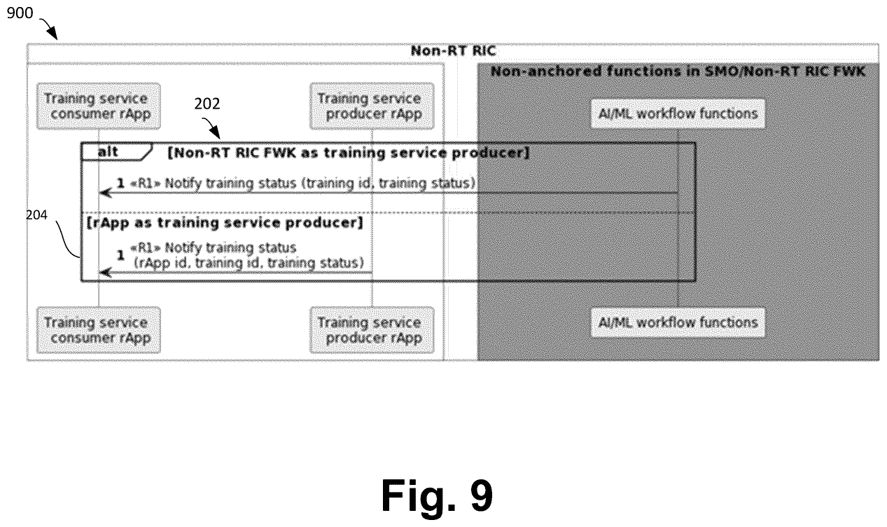

Let us now refer to FIG. 9, which shows the parts 900 of end-to-end (E2E) sequence diagram 200 of FIG. 2 that relate to the training service consumer rApp being notified of training status of training of an AI/ML model with the following two alternatives: (a) where the training service producer corresponds to the AI/ML workflow functions 112 of the non-RT RIC FWK 108 of FIG. 1 as shown at 202 in FIGS. 2 and 9; and (b) where the training service provider is an rApp as shown at 204 in FIGS. 2 and 9.

### G.1. R1 Use Case

This use case allows a training service producer to notify the training status of a created training job to the training service consumer rApp.

TABLE 4

| Use Case | |
|---|---|
| Stage | Evolution/Specification |
| Goal | The training service producer notifies the training service |
| | consumer rApp about the training status of a created |
| | training job. |
| Actors and | Training service consumer rApp in the role of Service |
| Roles | Consumer. |
| | In alternative 1, the AI/ML workflow functions in the role |
| | of Service Producer. |
| | In alternative 2, the training service producer rApp in the |
| | role of the Service Producer. |
| Assumptions | n/a |
| Pre- | The training service consumer rApp is deployed, |
| conditions | authenticated, and authorized to consume training |
| | services. |
| | The training service producer rApp is deployed, |
| | authenticated, and authorized to produce training |
| | services. |
| Begins when | The training service producer determines the need to notify |
| | training status to the training service consumer rApp. |
| Step 1 (M) | The training service producer notifies the training status to |
| | training service consumer rApp. |
| Ends when | The training service consumer rApp is notified about the |
| | training status. |
| Exceptions | n/a |
| Post | The training status is known to the training service |
| Conditions | consumer rApp. |
| Traceability | n/a |

### G.2. Service Operation

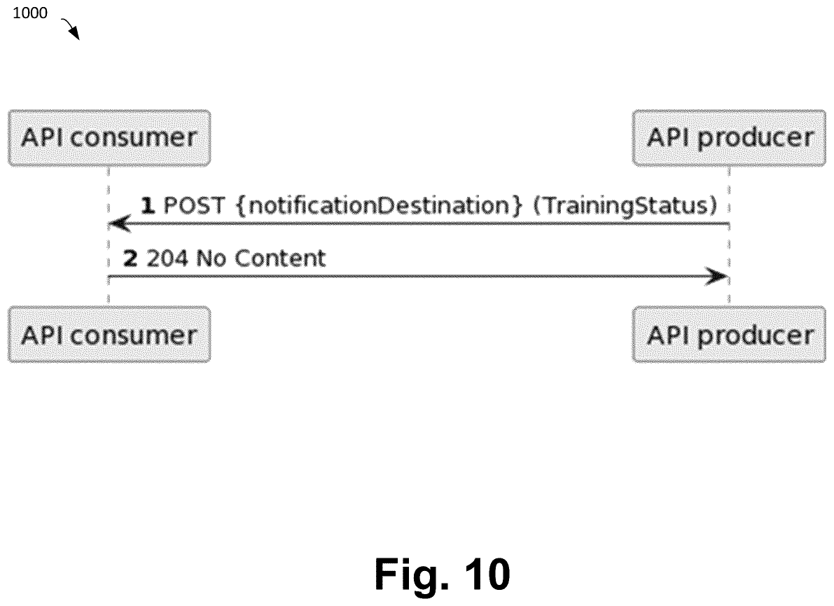

Let us now refer to FIG. 10, which shows a diagram 1000 of API operations which the API producer uses to notify the training status to the API consumer. The operation is based on HTTP POST.

The service operation is as follows:
1) The API producer shall send an HTTP POST request to the API consumer. The target URI shall identify the destination for the notification. The message body shall carry the training status.
2) The API consumer shall return the HTTP POST response. On success, “204 No Content” shall be returned to acknowledge the reception of the notification, and the message body shall be empty. On failure, appropriate error code shall be returned, and the message response body may contain additional error information.

### H. AI/ML Training API Definition

### H.1. Resource Structure and Methods

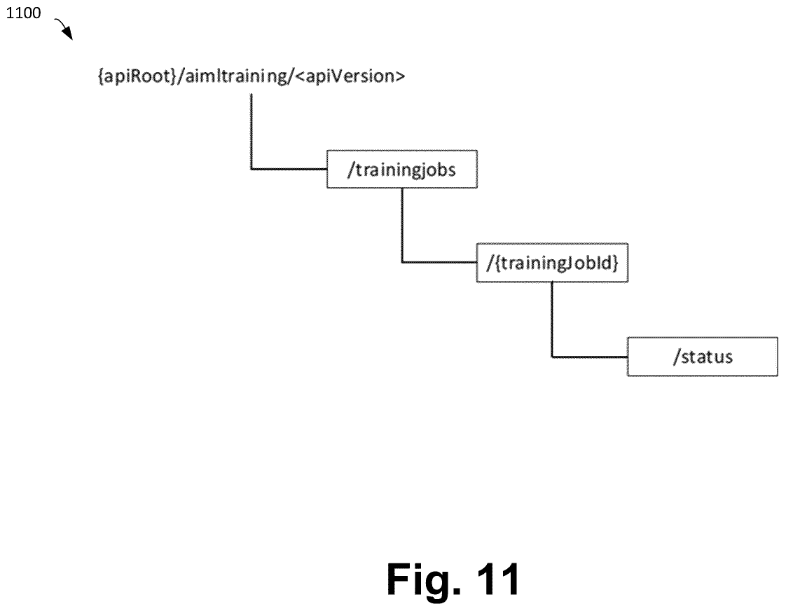

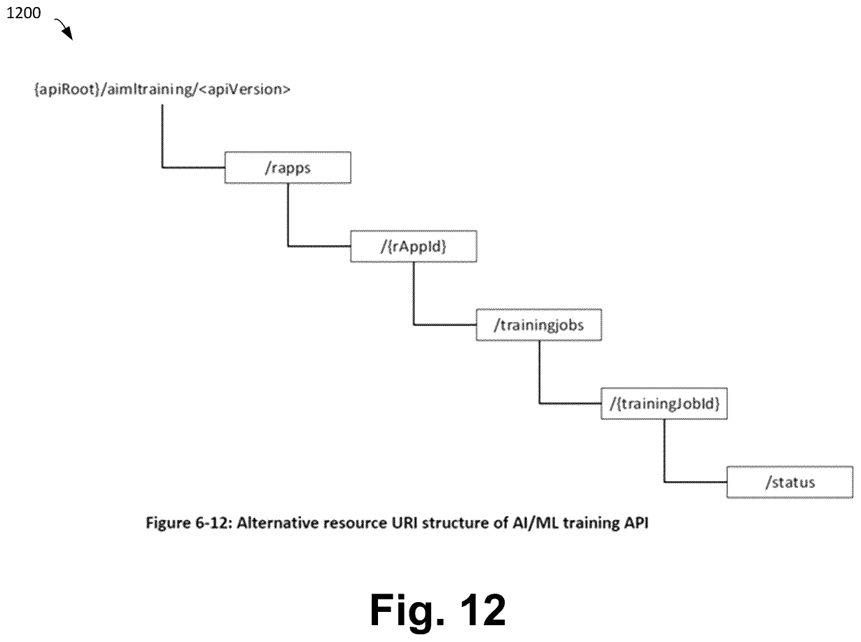

FIGS. 11 and 12 show the overall resource uniform resource identifier (URI) structure defined for a training service API according to some embodiments.

In one embodiment as shown in FIG. 11, a resource URI structure may correspond to the URI structure 1100 of FIG. 11.

In another embodiment, as shown in FIG. 12, a resource URI structure may correspond to the URI structure 1200 of FIG. 12.

The description to follow regarding URI is based on the first option of the URI structure as shown in FIG. 11. However, the URI based techniques of embodiments as described below may be adapted to the alternative URI structure of FIG. 12 in accordance with other embodiments.

Table 5 below lists the resources defined for the API, the applicable HTTP methods, and associated service operations for a resource URI structure according to some embodiments.

TABLE 5

| Resource | | HTTP | Service |
|---|---|---|---|
| name | Resource URI | method | Operation |
| Training | .../trainingjobs | POST | Create a |
| jobs | | | training |
| | | | job |
| Individual | .../trainingjobs/{trainingJobId} | DELETE | Stop a |
| training | | | training |
| job | | | job |
| Training | .../trainingjobs/{trainingJobId}/status | GET | Query |
| status of | | | training |
| individual | | | status of |
| training | | | a training |
| job | | | job |

### H.2. Resource: Training Jobs

Resource URI for “trainingjobs” may be as follows, according to an embodiment: {apiRoot}/aim|training/<apiVersion>/trainingjobs

### H.2.1. Resource Standard Methods

Resource standard methods for a resource URI for “trainingjobs” as noted above may include the following, according to some embodiments.

### H.2.1.1. HTTP POST

Data structures supported by the POST request body on this resource may as shown in Table 6 according to some embodiments.

TABLE 6

| Data type | P | Cardinality | Description |
|---|---|---|---|
| TrainingJobDescripton | M | 1 | Information related the |
| | | | training request. |

Data structures supported by the POST response body on this resource may as shown in Table 7 according to some embodiments.

TABLE 7

| | | | Response | |
|---|---|---|---|---|
| Data type | P | Cardinality | codes | Description |
| TrainingJobDescripton | M | 1 | 201 Created | The operation was |
| | | | | successful, and the POST |
| | | | | response contains a |
| | | | | TrainingJobDescription |
| | | | | structure as a |
| | | | | representation of the |
| | | | | created resource. |
| ProblemDetails | O | 0 . . . 1 | 4xx/5xx | The operation was failed, |
| | | | | and message body may |
| | | | | contain problem |
| | | | | description details |

A header as supported by the 201 Created HTTP response code on this resource may be as shown in Table 8 according to some embodiments.

TABLE 8

| | Data | | | |
|---|---|---|---|---|
| Name | type | P | Cardinality | Description |
| Location | string | M | 1 | Contains the URI of the created |
| | | | | training job resource with the |
| | | | | trainingJobId as the identifier. |

### H.3. Resource: Individual Training Job

Resource URI for “trainingjobId” may be as follows, according to an embodiment: Resource URI: {apiRoot}/aimltraining/<apiVersion>/trainingjobs/{trainingJobId}

### H.3.1. Resource Standard Methods

Resource standard method for individual training job as noted above may include the following, according to some embodiments.

### H.3.1.1. HTTP DELETE

Data structures supported by the DELETE request body on this resource may be as shown in Table 9 as follows:

TABLE 9

| | | | |
|---|---|---|---|
| Data type | P | Cardinality | Description |

n/a

Data structure supported by the DELETE response body on this resource may be as shown in Table 10 as follows:

TABLE 10

| | | | Response | |
|---|---|---|---|---|
| Data type | P | Cardinality | codes | Description |
| n/a | M | 1 | 204 No | The operation was |
| | | | Content | successful, and the |
| | | | | training job identified by |
| | | | | trainingJobId has been |
| | | | | deleted. The message |
| | | | | content shall be empty |
| ProblemDetails | O | 0 . . . 1 | 4xx/5xx | The operation was failed, |
| | | | | and message body may |
| | | | | contain problem |
| | | | | description details |

H.4. Resource: training status of an individual training job

Resource URI for “status” may be as follows, according to an embodiment: Resource URI: {apiRoot}/aimltraining/<apiVersion>/trainingjobs/{trainingJobId}/status

### H.4.1. Resource Standard Methods

Resource standard method for training status of an individual training job as noted above may include the following, according to some embodiments.

### H.4.1.1. HTTP GET

URI query parameters supported by the GET method on the status resource may be as shown in Table 11 as follows:

TABLE 11

| | | | | |
|---|---|---|---|---|
| | Data | | | |
| Name | type | P | Cardinality | Description |

n/a

Data structures supported by the GET request body on the status resource may be as shown in Table 12 as follows:

TABLE 12

| | | | |
|---|---|---|---|
| Data type | P | Cardinality | Description |

n/a

A data structure supported by the GET response body on the status resource may be as shown in Table 13 as follows:

TABLE 13

| | | | Response | |
|---|---|---|---|---|
| Data type | P | Cardinality | codes | Description |
| TrainingStatusType | M | 1 | 200 OK | The operation was |
| | | | | successful, and the |
| | | | | GET response |
| | | | | contains a |
| | | | | TrainingStatus |
| | | | | structure as a |
| | | | | representation of |
| | | | | the training status |
| | | | | of the training job |
| | | | | identified by the |
| | | | | trainingJobId. |
| ProblemDetails | O | 0 . . . 1 | 4xx/5xx | The operation was |
| | | | | failed, and message |
| | | | | body may contain |
| | | | | problem description |
| | | | | details |

### H.5. Notifications

The notifications overview may be as shown in Table 14 as follows:

TABLE 14

| | | HTTP | |
|---|---|---|---|
| Notification | Callback URI | method | Service Operation |
| Training status | {notificationDestination} | POST | Notify training |
| notification | | | status of a created |
| | | | training |

### H.6. Notification: Training Status Notification

Resource URI for a training status notification may be as follows, according to an embodiment: Callback URI: {notificationDestination}

### H.6.1. Resource Standard Methods

Resource standard methods for a resource URI for training status notification as noted above may include the following, according to some embodiments.

### H.6.1.1. HTTP POST

Data structures supported by the POST request body on this resource may be as shown in Table 15 as follows:

TABLE 15

| Data type | P | Cardinality | Description |
|---|---|---|---|
| TrainingStatus | M | 1 | Notification of the training status. |

Data structure supported by the POST response body on this resource may be as shown in Table 16 as follows:

TABLE 16

| | | | Response | |
|---|---|---|---|---|
| Data type | P | Cardinality | codes | Description |
| n/a | | | 204 No | The operation was |
| | | | Content | successful, and the |
| | | | | notification is |
| | | | | acknowledged. |
| ProblemDetails | O | 0 . . . 1 | 4xx/5xx | The operation was failed, |
| | | | | and message body may |
| | | | | contain problem |
| | | | | description details |

### 1. Data Model

The definition of type TrainingJobDescripton may be as shown in Table 17 as follows:

TABLE 17

| Attribute Name | Data type | P | Cardinality | Description |
|---|---|---|---|---|
| trainingDataInfo | TrainngDataInfo | M | 1 | Information of the training |
| | | | | data |
| modelAccessInfo | ModelAccessInfo | M | 1 | Information of model access |
| | | | | details |
| trainingCriteriaInfo | TrainigCriteriaInfo | O | 0 . . . 1 | Information of training |
| | | | | criteria |
| notificationDestination | Uri | M | 1 | URI where the notification |
| | | | | should be delivered to. |
| consumerRAppId | string | O | 0 . . . 1 | rAppId of the training service |
| | | | | consumer rApp. |
| producerRAppId | string | O | 0 . . . 1 | rAppId of the training service |
| | | | | producer rApp. |

The definition of type ModelAccessInfo may be as shown in Table 18 as follows:

TABLE 18

| Attribute | | | | |
|---|---|---|---|---|
| Name | Data type | P | Cardinality | Description |
| modelId | string | M | 1 | Model identifier of the |
| | | | | model to be trained |
| modelVersion | string | O | 0 . . . 1 | Version number of the |
| | | | | model to be trained |
| modelRequest | InterfaceDescription | M | 1 | Endpoint to obtain the |
| Endpoint | | | | model. Data type |
| | | | | InterfaceDescription is |
| | | | | defined in 3GPP TS 29.222 |
| | | | | Clause 8.2.4.2.3 |

The definition of type TrainingStatusNotification may be as shown in Table 19 as follows:

TABLE 19

| Attribute | | | | |
|---|---|---|---|---|
| Name | Data type | P | Cardinality | Description |
| trainingId | string | M | 1 | Training job |
| | | | | identifier |
| trainingStatus | TrainingStatusType | O | 0 . . . 1 | Version |
| | | | | number of |
| | | | | the model to |
| | | | | be trained |

The enumeration of TrainingStatusType may be defined as shown in Table 20 as follows:

TABLE 20

| Enumeration | |
|---|---|
| value | Description |
| COMPLETED | Training is successfully completed |
| IN_PROGRESS | Training is not completed, and it is ongoing |
| ON_HOLD | Training is not completed, and it is on hold by the |
| | training service producer |
| ABORTED | Training is stopped by the training service producer |
| TIME_OUT | Training job is completed but failed to meet the |
| | training criteria |
| CANCELLED | Training is stopped by the training service consumer |

### Systems and Implementations

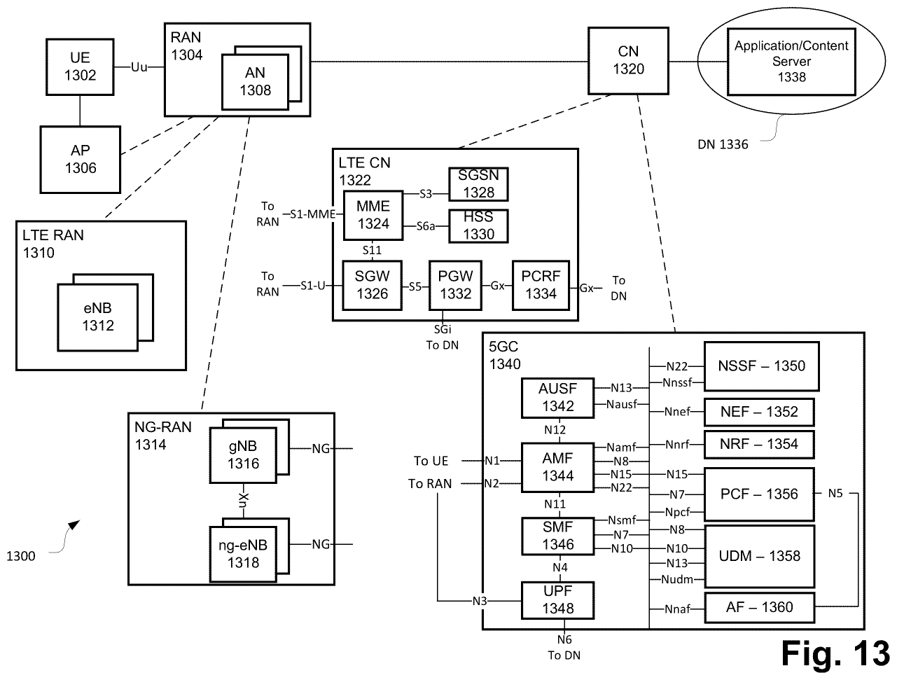

FIGS. 13-19 illustrate various systems, devices, and components that may implement aspects of disclosed embodiments.

FIG. 13 illustrates a network 1300 in accordance with various embodiments. The network 1300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1300 may include a UE 1302, which may include any mobile or non-mobile computing device designed to communicate with a RAN 1304 via an over-the-air connection. The UE 1302 may be communicatively coupled with the RAN 1304 by a Uu interface. The UE 1302 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1300 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1302 may additionally communicate with an AP 1306 via an over-the-air connection. The AP 1306 may manage a WLAN connection, which may serve to offload some/all network traffic from the RAN 1304. The connection between the UE 1302 and the AP 1306 may be consistent with any IEEE 802.11 protocol, wherein the AP 1306 could be a wireless fidelity (Wi-Fi®) router. In some embodiments, the UE 1302, RAN 1304, and AP 1306 may utilize cellular-WLAN aggregation (for example, LWA/LWIP). Cellular-WLAN aggregation may involve the UE 1302 being configured by the RAN 1304 to utilize both cellular radio resources and WLAN resources.

The RAN 1304 may include one or more access nodes, for example, AN 1308. AN 1308 may terminate air-interface protocols for the UE 1302 by providing access stratum protocols including RRC, PDCP, RLC, MAC, and L1 protocols. In this manner, the AN 1308 may enable data/voice connectivity between CN 1320 and the UE 1302. In some embodiments, the AN 1308 may be implemented in a discrete device or as one or more software entities running on server computers as part of, for example, a virtual network, which may be referred to as a CRAN or virtual baseband unit pool. The AN 1308 be referred to as a BS, gNB, RAN node, eNB, ng-eNB, NodeB, RSU, TRxP, TRP, etc. The AN 1308 may be a macrocell base station or a low power base station for providing femtocells, picocells or other like cells having smaller coverage areas, smaller user capacity, or higher bandwidth compared to macrocells.

In embodiments in which the RAN 1304 includes a plurality of ANs, they may be coupled with one another via an X2 interface (if the RAN 1304 is an LTE RAN) or an Xn interface (if the RAN 1304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1304 may each manage one or more cells, cell groups, component carriers, etc. to provide the UE 1302 with an air interface for network access. The UE 1302 may be simultaneously connected with a plurality of cells provided by the same or different ANs of the RAN 1304. For example, the UE 1302 and RAN 1304 may use carrier aggregation to allow the UE 1302 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1302 or AN 1308 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1304 may be an LTE RAN 1310 with eNBs, for example, eNB 1312. The LTE RAN 1310 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1304 may be an NG-RAN 1314 with gNBs, for example, gNB 1316, or ng-eNBs, for example, ng-eNB 1318. The gNB 1316 may connect with 5G-enabled UEs using a 5G NR interface. The gNB 1316 may connect with a 5G core through an NG interface, which may include an N2 interface or an N3 interface. The ng-eNB 1318 may also connect with the 5G core through an NG interface, but may connect with a UE via an LTE air interface. The gNB 1316 and the ng-eNB 1318 may connect with each other over an Xn interface.

In some embodiments, the NG interface may be split into two parts, an NG user plane (NG-U) interface, which carries traffic data between the nodes of the NG-RAN 1314 and a UPF 1348 (e.g., N3 interface), and an NG control plane (NG-C) interface, which is a signaling interface between the nodes of the NG-RAN 1314 and an AMF 1344 (e.g., N2 interface).

The NG-RAN 1314 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1302 can be configured with multiple BWPs where each BWP configuration has a different SCS. When a BWP change is indicated to the UE 1302, the SCS of the transmission is changed as well. Another use case example of BWP is related to power saving. In particular, multiple BWPs can be configured for the UE 1302 with different amount of frequency resources (for example, PRBs) to support data transmission under different traffic loading scenarios. A BWP containing a smaller number of PRBs can be used for data transmission with small traffic load while allowing power saving at the UE 1302 and in some cases at the gNB 1316. A BWP containing a larger number of PRBs can be used for scenarios with higher traffic load.

The RAN 1304 is communicatively coupled to CN 1320 that includes network elements to provide various functions to support data and telecommunications services to customers/subscribers (for example, users of UE 1302). The components of the CN 1320 may be implemented in one physical node or separate physical nodes. In some embodiments, NFV may be utilized to virtualize any or all of the functions provided by the network elements of the CN 1320 onto physical compute/storage resources in servers, switches, etc. A logical instantiation of the CN 1320 may be referred to as a network slice, and a logical instantiation of a portion of the CN 1320 may be referred to as a network sub-slice.

In some embodiments, the CN 1320 may be an LTE CN 1322, which may also be referred to as an EPC. The LTE CN 1322 may include MME 1324, SGW 1326, SGSN 1328, HSS 1330, PGW 1332, and PCRF 1334 coupled with one another over interfaces (or “reference points”) as shown. Functions of the elements of the LTE CN 1322 may be briefly introduced as follows.

The MME 1324 may implement mobility management functions to track a current location of the UE 1302 to facilitate paging, bearer activation/deactivation, handovers, gateway selection, authentication, etc.

The SGW 1326 may terminate an S1 interface toward the RAN and route data packets between the RAN and the LTE CN 1322. The SGW 1326 may be a local mobility anchor point for inter-RAN node handovers and also may provide an anchor for inter-3GPP mobility. Other responsibilities may include lawful intercept, charging, and some policy enforcement.

The SGSN 1328 may track a location of the UE 1302 and perform security functions and access control. In addition, the SGSN 1328 may perform inter-EPC node signaling for mobility between different RAT networks; PDN and S-GW selection as specified by MME 1324; MME selection for handovers; etc. The S3 reference point between the MME 1324 and the SGSN 1328 may enable user and bearer information exchange for inter-3GPP access network mobility in idle/active states.

The HSS 1330 may include a database for network users, including subscription-related information to support the network entities' handling of communication sessions. The HSS 1330 can provide support for routing/roaming, authentication, authorization, naming/addressing resolution, location dependencies, etc. An S6a reference point between the HSS 1330 and the MME 1324 may enable transfer of subscription and authentication data for authenticating/authorizing user access to the LTE CN 1320.

The PGW 1332 may terminate an SGi interface toward a data network (DN) 1336 that may include an application/content server 1338. The PGW 1332 may route data packets between the LTE CN 1322 and the data network 1336. The PGW 1332 may be coupled with the SGW 1326 by an S5 reference point to facilitate user plane tunneling and tunnel management. The PGW 1332 may further include a node for policy enforcement and charging data collection (for example, PCEF). Additionally, the SGi reference point between the PGW 1332 and the data network YX 36 may be an operator external public, a private PDN, or an intra-operator packet data network, for example, for provision of IMS services. The PGW 1332 may be coupled with a PCRF 1334 via a Gx reference point.

The PCRF 1334 is the policy and charging control element of the LTE CN 1322. The PCRF 1334 may be communicatively coupled to the app/content server 1338 to determine appropriate QoS and charging parameters for service flows. The PCRF 1334 may provision associated rules into a PCEF (via Gx reference point) with appropriate TFT and QCI.

In some embodiments, the CN 1320 may be a 5GC 1340. The 5GC 1340 may include an AUSF 1342, AMF 1344, SMF 1346, UPF 1348, NSSF 1350, NEF 1352, NRF 1354, PCF 1356, UDM 1358, and AF 1360 coupled with one another over interfaces (or “reference points”) as shown. Functions of the elements of the 5GC 1340 may be briefly introduced as follows.

The AUSF 1342 may store data for authentication of UE 1302 and handle authentication-related functionality. The AUSF 1342 may facilitate a common authentication framework for various access types. In addition to communicating with other elements of the 5GC 1340 over reference points as shown, the AUSF 1342 may exhibit an Nausf service-based interface.

The AMF 1344 may allow other functions of the 5GC 1340 to communicate with the UE 1302 and the RAN 1304 and to subscribe to notifications about mobility events with respect to the UE 1302. The AMF 1344 may be responsible for registration management (for example, for registering UE 1302), connection management, reachability management, mobility management, lawful interception of AMF-related events, and access authentication and authorization. The AMF 1344 may provide transport for SM messages between the UE 1302 and the SMF 1346, and act as a transparent proxy for routing SM messages. AMF 1344 may also provide transport for SMS messages between UE 1302 and an SMSF. AMF 1344 may interact with the AUSF 1342 and the UE 1302 to perform various security anchor and context management functions. Furthermore, AMF 1344 may be a termination point of a RAN CP interface, which may include or be an N2 reference point between the RAN 1304 and the AMF 1344; and the AMF 1344 may be a termination point of NAS (N1) signaling, and perform NAS ciphering and integrity protection. AMF 1344 may also support NAS signaling with the UE 1302 over an N3 IWF interface.

The SMF 1346 may be responsible for SM (for example, session establishment, tunnel management between UPF 1348 and AN 1308); UE IP address allocation and management (including optional authorization); selection and control of UP function; configuring traffic steering at UPF 1348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1344 over N2 to AN 1308; and determining SSC mode of a session. SM may refer to management of a PDU session, and a PDU session or “session” may refer to a PDU connectivity service that provides or enables the exchange of PDUs between the UE 1302 and the data network 1336.

The UPF 1348 may act as an anchor point for intra-RAT and inter-RAT mobility, an external PDU session point of interconnect to data network 1336, and a branching point to support multi-homed PDU session. The UPF 1348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1348 may include an uplink classifier to support routing traffic flows to a data network.

The NSSF 1350 may select a set of network slice instances serving the UE 1302. The NSSF 1350 may also determine allowed NSSAI and the mapping to the subscribed S-NSSAIs, if needed. The NSSF 1350 may also determine the AMF set to be used to serve the UE 1302, or a list of candidate AMFs based on a suitable configuration and possibly by querying the NRF 1354. The selection of a set of network slice instances for the UE 1302 may be triggered by the AMF 1344 with which the UE 1302 is registered by interacting with the NSSF 1350, which may lead to a change of AMF. The NSSF 1350 may interact with the AMF 1344 via an N22 reference point; and may communicate with another NSSF in a visited network via an N31 reference point (not shown). Additionally, the NSSF 1350 may exhibit an Nnssf service-based interface.

The NEF 1352 may securely expose services and capabilities provided by 3GPP network functions for third party, internal exposure/re-exposure, AFs (e.g., AF 1360), edge computing or fog computing systems, etc. In such embodiments, the NEF 1352 may authenticate, authorize, or throttle the AFs. NEF 1352 may also translate information exchanged with the AF 1360 and information exchanged with internal network functions. For example, the NEF 1352 may translate between an AF-Service-Identifier and an internal 5GC information. NEF 1352 may also receive information from other NFs based on exposed capabilities of other NFs. This information may be stored at the NEF 1352 as structured data, or at a data storage NF using standardized interfaces. The stored information can then be re-exposed by the NEF 1352 to other NFs and AFs, or used for other purposes such as analytics. Additionally, the NEF 1352 may exhibit an Nnef service-based interface.

The NRF 1354 may support service discovery functions, receive NF discovery requests from NF instances, and provide the information of the discovered NF instances to the NF instances. NRF 1354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1354 may exhibit the Nnrf service-based interface.

The PCF 1356 may provide policy rules to control plane functions to enforce them, and may also support unified policy framework to govern network behavior. The PCF 1356 may also implement a front end to access subscription information relevant for policy decisions in a UDR of the UDM 1358. In addition to communicating with functions over reference points as shown, the PCF 1356 exhibit an Npcf service-based interface.

The UDM 1358 may handle subscription-related information to support the network entities' handling of communication sessions, and may store subscription data of UE 1302. For example, subscription data may be communicated via an N8 reference point between the UDM 1358 and the AMF 1344. The UDM 1358 may include two parts, an application front end and a UDR. The UDR may store subscription data and policy data for the UDM 1358 and the PCF 1356, and/or structured data for exposure and application data (including PFDs for application detection, application request information for multiple UEs 1302) for the NEF 1352. The Nudr service-based interface may be exhibited by the UDM 1358 to allow the UDM 1358, PCF 1356, and NEF 1352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1358 may exhibit the Nudm service-based interface.

The AF 1360 may provide application influence on traffic routing, provide access to NEF, and interact with the policy framework for policy control.

In some embodiments, the 5GC 1340 may enable edge computing by selecting operator/3rd party services to be geographically close to a point that the UE 1302 is attached to the network. This may reduce latency and load on the network. To provide edge-computing implementations, the 5GC 1340 may select a UPF 1348 close to the UE 1302 and execute traffic steering from the UPF 1348 to data network 1336 via the N6 interface. This may be based on the UE subscription data, UE location, and information provided by the AF 1360. In this way, the AF 1360 may influence UPF (re) selection and traffic routing. Based on operator deployment, when AF 1360 is considered to be a trusted entity, the network operator may permit AF 1360 to interact directly with relevant NFs. Additionally, the AF 1360 may exhibit an Naf service-based interface.

The data network 1336 may represent various network operator services, Internet access, or third party services that may be provided by one or more servers including, for example, application/content server 1338.

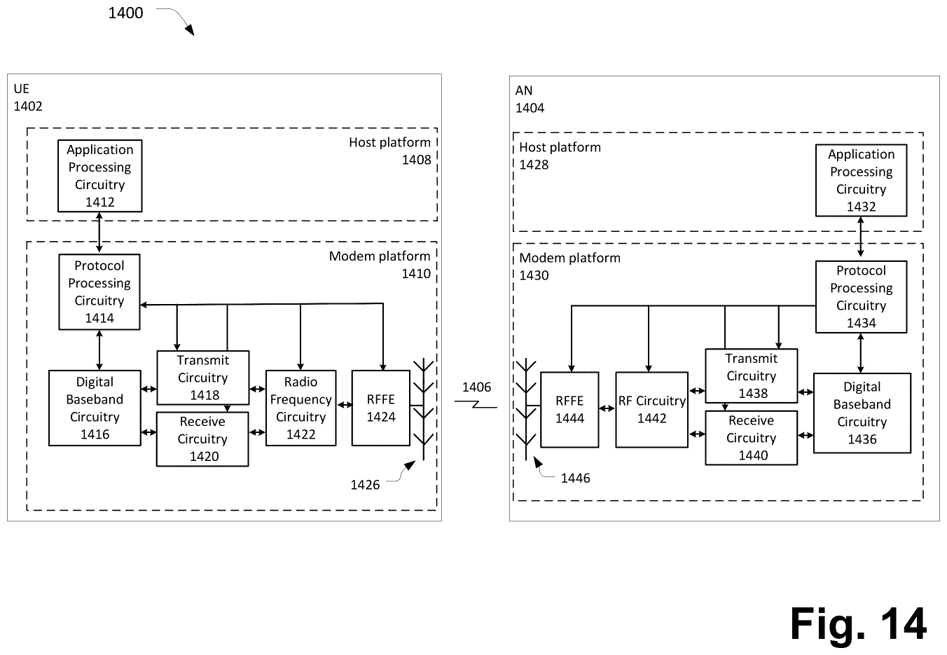

FIG. 14 schematically illustrates a wireless network 1400 in accordance with various embodiments. The wireless network 1400 may include a UE 1402 in wireless communication with an AN 1404. The UE 1402 and AN 1404 may be similar to, and substantially interchangeable with, like-named components described elsewhere herein.

The UE 1402 may be communicatively coupled with the AN 1404 via connection 1406. The connection 1406 is illustrated as an air interface to enable communicative coupling, and can be consistent with cellular communications protocols such as an LTE protocol or a 5G NR protocol operating at mmWave or sub-6 GHZ frequencies.

The UE 1402 may include a host platform 1408 coupled with a modem platform 1410. The host platform 1408 may include application processing circuitry 1412, which may be coupled with protocol processing circuitry 1414 of the modem platform 1410. The application processing circuitry 1412 may run various applications for the UE 1402 that source/sink application data. The application processing circuitry 1412 may further implement one or more layer operations to transmit/receive application data to/from a data network. These layer operations may include transport (for example UDP) and Internet (for example, IP) operations

The protocol processing circuitry 1414 may implement one or more of layer operations to facilitate transmission or reception of data over the connection 1406. The layer operations implemented by the protocol processing circuitry 1414 may include, for example, MAC, RLC, PDCP, RRC and NAS operations.

The modem platform 1410 may further include digital baseband circuitry 1416 that may implement one or more layer operations that are “below” layer operations performed by the protocol processing circuitry 1414 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1410 may further include transmit circuitry 1418, receive circuitry 1420, RF circuitry 1422, and RF front end (RFFE) 1424, which may include or connect to one or more antenna panels 1426. Briefly, the transmit circuitry 1418 may include a digital-to-analog converter, mixer, intermediate frequency (IF) components, etc.; the receive circuitry 1420 may include an analog-to-digital converter, mixer, IF components, etc.; the RF circuitry 1422 may include a low-noise amplifier, a power amplifier, power tracking components, etc.; RFFE 1424 may include filters (for example, surface/bulk acoustic wave filters), switches, antenna tuners, beamforming components (for example, phase-array antenna components), etc. The selection and arrangement of the components of the transmit circuitry 1418, receive circuitry 1420, RF circuitry 1422, RFFE 1424, and antenna panels 1426 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1414 may include one or more instances of control circuitry (not shown) to provide control functions for the transmit/receive components.

A UE reception may be established by and via the antenna panels 1426, RFFE 1424, RF circuitry 1422, receive circuitry 1420, digital baseband circuitry 1416, and protocol processing circuitry 1414. In some embodiments, the antenna panels 1426 may receive a transmission from the AN 1404 by receive-beamforming signals received by a plurality of antennas/antenna elements of the one or more antenna panels 1426.

A UE transmission may be established by and via the protocol processing circuitry 1414, digital baseband circuitry 1416, transmit circuitry 1418, RF circuitry 1422, RFFE 1424, and antenna panels 1426. In some embodiments, the transmit components of the UE 1402 may apply a spatial filter to the data to be transmitted to form a transmit beam emitted by the antenna elements of the antenna panels 1426.

Similar to the UE 1402, the AN 1404 may include a host platform 1428 coupled with a modem platform 1430. The host platform 1428 may include application processing circuitry 1432 coupled with protocol processing circuitry 1434 of the modem platform 1430. The modem platform may further include digital baseband circuitry 1436, transmit circuitry 1438, receive circuitry 1440, RF circuitry 1442, RFFE circuitry 1444, and antenna panels 1446. The components of the AN 1404 may be similar to and substantially interchangeable with like-named components of the UE 1402. In addition to performing data transmission/reception as described above, the components of the AN 1408 may perform various logical functions that include, for example, RNC functions such as radio bearer management, uplink and downlink dynamic radio resource management, and data packet scheduling.

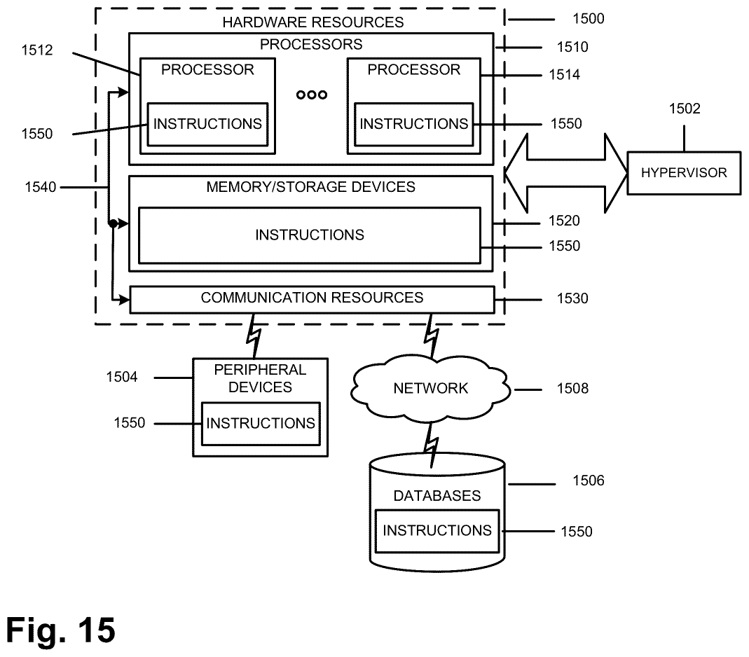

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540 or other interface circuitry. For embodiments where node virtualization (e.g., NFV) is utilized, a hypervisor 1502 may be executed to provide an execution environment for one or more network slices/sub-slices to utilize the hardware resources 1500.

The processors 1510 may include, for example, a processor 1512 and a processor 1514. The processors 1510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1520 may include main memory, disk storage, or any suitable combination thereof. The memory/storage devices 1520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1530 may include interconnection or network interface controllers, components, or other suitable devices to communicate with one or more peripheral devices 1504 or one or more databases 1506 or other network elements via a network 1508. For example, the communication resources 1530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

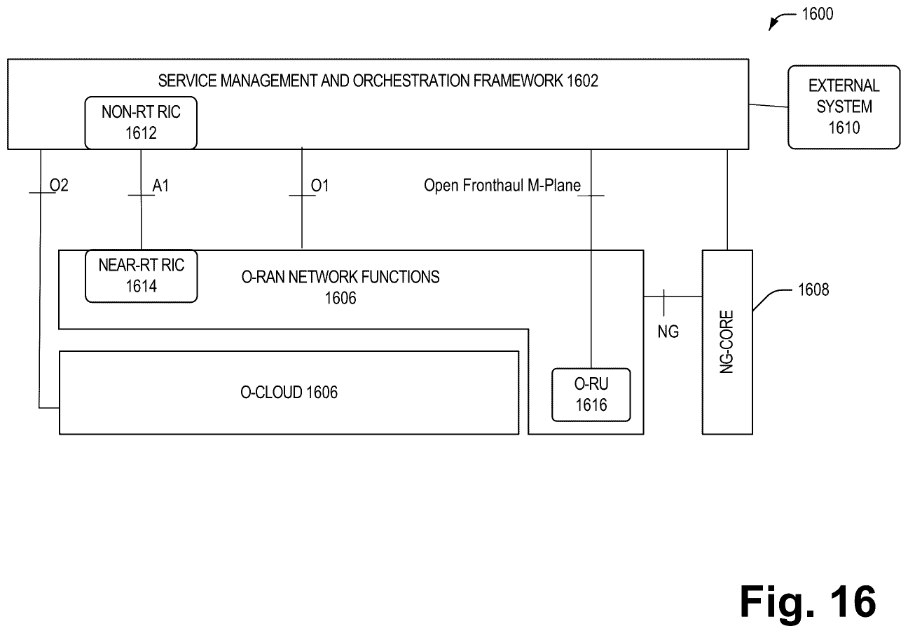

FIG. 16 provides a high-level view of an Open RAN (O-RAN) architecture 1600, comparable in some aspects to that of architecture 100 of FIG. 1. The O-RAN architecture 1600 includes four O-RAN defined interfaces-namely, the A1 interface, the O1 interface, the O2 interface, and the Open Fronthaul Management (M)-plane interface-which connect the Service Management and Orchestration (SMO) framework 1602 to O-RAN network functions (NFs) 1604 and the O-Cloud 1606. The SMO 1602 (described in [O13]) also connects with an external system 1610, which provides enrichment data to the SMO 1602. FIG. 16 also illustrates that the A1 interface terminates at an O-RAN Non-Real Time (RT) RAN Intelligent Controller (RIC) 1612 (similar for example of non-RT RIC 104 of FIG. 1) in or at the SMO 1602 and at the O-RAN Near-RT RIC 1614 in or at the O-RAN NFs 1604. The O-RAN NFs 1604 can be VNFs such as VMs or containers, sitting above the O-Cloud 1606 and/or Physical Network Functions (PNFs) utilizing customized hardware. All O-RAN NFs 1604 are expected to support the O1 interface when interfacing the SMO framework 1602. The O-RAN NFs 1604 connect to the NG-Core 1608 via the NG interface (which is a 3GPP defined interface). The Open Fronthaul M-plane interface between the SMO 1602 and the O-RAN Radio Unit (O-RU) 1616 supports the O-RU 1616 management in the O-RAN hybrid model as specified in [O16]. The Open Fronthaul M-plane interface is an optional interface to the SMO 1602 that is included for backward compatibility purposes as per [O16], and is intended for management of the O-RU 1616 in hybrid mode only. The management architecture of flat mode and its relation to the O1 interface for the O-RU 1616 is for future study. The O-RU 1616 termination of the O1 interface towards the SMO 1602 as specified in [O12].

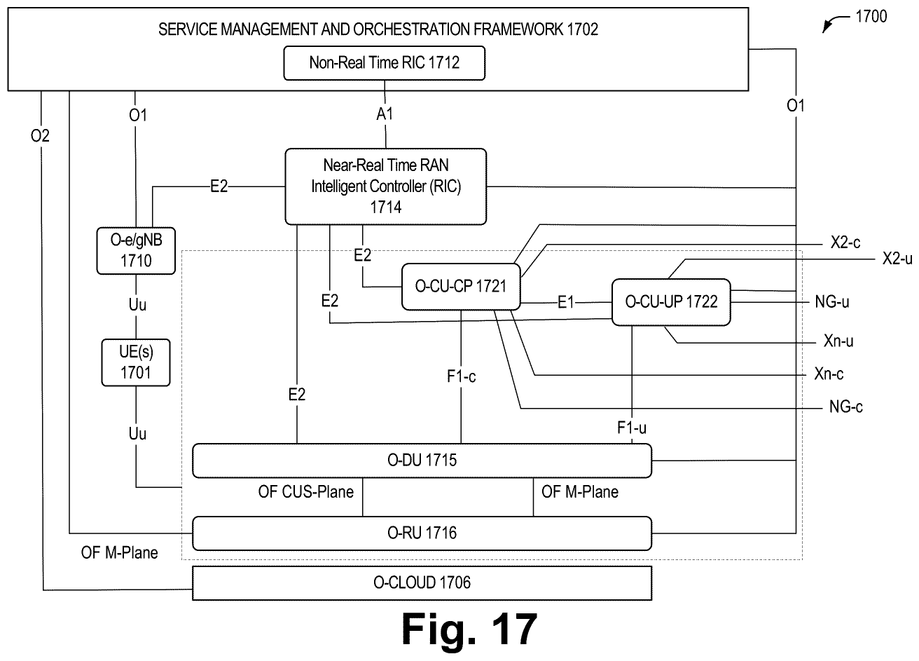

FIG. 17 shows an O-RAN logical architecture 1700 corresponding to the O-RAN architecture 1600 of FIG. 16. In FIG. 17, the SMO 1702 corresponds to the SMO 1602, O-Cloud 1706 corresponds to the O-Cloud 1606, the non-RT RIC 1712 corresponds to the non-RT RIC 1612, the near-RT RIC 1714 corresponds to the near-RT RIC 1614, and the O-RU 1716 corresponds to the O-RU 1616 of FIG. 17, respectively. The O-RAN logical architecture 1700 includes a radio portion and a management portion.

The management portion/side of the architectures 1700 includes the SMO Framework 1702 containing the non-RT RIC 1712, and may include the O-Cloud 1706. The O-Cloud 1706 is a cloud computing platform including a collection of physical infrastructure nodes to host the relevant O-RAN functions (e.g., the near-RT RIC 1714, O-CU-CP 1721, O-CU-UP 1722, and the O-DU 1715), supporting software components (e.g., OSs, VMMs, container runtime engines, ML engines, etc.), and appropriate management and orchestration functions.

The radio portion/side of the logical architecture 1700 includes the near-RT RIC 1714, the O-RAN Distributed Unit (O-DU) 1715, the O-RU 1716, the O-RAN Central Unit-Control Plane (O-CU-CP) 1721, and the O-RAN Central Unit-User Plane (O-CU-UP) 1722 functions. The radio portion/side of the logical architecture 1700 may also include the O-e/gNB 1710.

The O-DU 1715 is a logical node hosting RLC, MAC, and higher PHY layer entities/elements (High-PHY layers) based on a lower layer functional split. The O-RU 1716 is a logical node hosting lower PHY layer entities/elements (Low-PHY layer) (e.g., FFT/iFFT, PRACH extraction, etc.) and RF processing elements based on a lower layer functional split. Virtualization of O-RU 1716 is FFS. The O-CU-CP 1721 is a logical node hosting the RRC and the control plane (CP) part of the PDCP protocol. The O O-CU-UP 1722 is a a logical node hosting the user plane part of the PDCP protocol and the SDAP protocol.

An E2 interface terminates at a plurality of E2 nodes. The E2 nodes are logical nodes/entities that terminate the E2 interface. For NR/5G access, the E2 nodes include the O-CU-CP 1721, O-CU-UP 1722, O-DU 1715, or any combination of elements as defined in [O15]. For E-UTRA access the E2 nodes include the O-e/gNB 1710. As shown in FIG. 17, the E2 interface also connects the O-e/gNB 1710 to the Near-RT RIC 1714. The protocols over E2 interface are based exclusively on Control Plane (CP) protocols. The E2 functions are grouped into the following categories: (a) near-RT RIC 1714 services (REPORT, INSERT, CONTROL and POLICY, as described in [O15]); and (b) near-RT RIC 1714 support functions, which include E2 Interface Management (E2 Setup, E2 Reset, Reporting of General Error Situations, etc.) and Near-RT RIC Service Update (e.g., capability exchange related to the list of E2 Node functions exposed over E2).

FIG. 17 shows the Uu interface between a UE 1701 and O-e/gNB 1710 as well as between the UE 1701 and O-RAN components. The Uu interface is a 3GPP defined interface (see e.g., sections 5.2 and 5.3 of [O07]), which includes a complete protocol stack from L1 to L3 and terminates in the NG-RAN or E-UTRAN. The O-e/gNB 1710 is an LTE eNB [004], a 5G gNB or ng-eNB that supports the E2 interface. The O-e/gNB 1710 may be the same or similar as eNB 1312, gNB 1316, ng-eNB 1318, RAN 1808, RAN 1910, or some other base station, RAN, or nodeB discussed previously. The a UE 1701 may correspond to UEs 1302, 1402, 1802, UE 1905, or some other UE discussed with respect to other FIGS. herein, and/or the like. There may be multiple UEs 1701 and/or multiple O-e/gNB 1710, each of which may be connected to one another the via respective Uu interfaces. Although not shown in FIG. 17, the O-e/gNB 1710 supports O-DU 1715 and O-RU 1716 functions with an Open Fronthaul interface between them.

The Open Fronthaul (OF) interface(s) is/are between O-DU 1715 and O-RU 1716 functions [O16] [O17]. The OF interface(s) includes the Control User Synchronization (CUS) Plane and Management (M) Plane. FIGS. Or1 and Or2 also show that the O-RU 1716 terminates the OF M-Plane interface towards the O-DU 1715 and optionally towards the SMO 1702 as specified in [O16]. The O-RU 1716 terminates the OF CUS-Plane interface towards the O-DU 1715 and the SMO 1702.

The F1-c interface connects the O-CU-CP 1721 with the O-DU 1715. As defined by 3GPP, the F1-c interface is between the gNB-CU-CP and gNB-DU nodes [O10]. However, for purposes of O-RAN, the F1-c interface is adopted between the O-CU-CP 1721 with the O-DU 1715 functions while reusing the principles and protocol stack defined by 3GPP and the definition of interoperability profile specifications.

The F1-u interface connects the O-CU-UP 1722 with the O-DU 1715. As defined by 3GPP, the F1-u interface is between the gNB-CU-UP and gNB-DU nodes [010]. However, for purposes of O-RAN, the F1-u interface is adopted between the O-CU-UP 1722 with the O-DU 1715 functions while reusing the principles and protocol stack defined by 3GPP and the definition of interoperability profile specifications.

The NG-c interface is defined by 3GPP as an interface between the gNB-CU-CP and the AMF in the 5GC [O06]. The NG-c is also referred as the N2 interface (see [O06]). The NG-u interface is defined by 3GPP, as an interface between the gNB-CU-UP and the UPF in the 5GC [O06]. The NG-u interface is referred as the N3 interface (see [O06]). In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC (see e.g., [O05], [O06]). In O-RAN, X2-c and X2-u protocol stacks defined by 3GPP are reused and may be adapted for O-RAN purposes

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB (see e.g., [O06], [O08]). In O-RAN, Xn-c and Xn-u protocol stacks defined by 3GPP are reused and may be adapted for O-RAN purposes

The E1 interface is defined by 3GPP as being an interface between the gNB-CU-CP (e.g., gNB-CU-CP 3728) and gNB-CU-UP (see e.g., [O07], [O09]). In O-RAN, E1 protocol stacks defined by 3GPP are reused and adapted as being an interface between the O-CU-CP 1721 and the O-CU-UP 1722 functions.

The O-RAN Non-Real Time (RT) RAN Intelligent Controller (RIC) 1712 is a logical function within the SMO framework 1602, 1702 that enables non-real-time control and optimization of RAN elements and resources; AI/machine learning (ML) workflow(s) including model training, inferences, and updates; and policy-based guidance of applications/features in the Near-RT RIC 1714.

The O-RAN near-RT RIC 1714 is a logical function that enables near-real-time control and optimization of RAN elements and resources via fine-grained data collection and actions over the E2 interface. The near-RT RIC 1714 may include one or more AI/ML workflows including model training, inferences, and updates.

The non-RT RIC 1712 can be an ML training host to host the training of one or more ML models. ML training can be performed offline using data collected from the RIC, O-DU 1715 and O-RU 1716. For supervised learning, non-RT RIC 1712 is part of the SMO 1702, and the ML training host and/or ML model host/actor can be part of the non-RT RIC 1712 and/or the near-RT RIC 1714. For unsupervised learning, the ML training host and ML model host/actor can be part of the non-RT RIC 1712 and/or the near-RT RIC 1714. For reinforcement learning, the ML training host and ML model host/actor may be co-located as part of the non-RT RIC 1712 and/or the near-RT RIC 1714. In some implementations, the non-RT RIC 1712 may request or trigger ML model training in the training hosts regardless of where the model is deployed and executed. ML models may be trained and not currently deployed.

In some implementations, the non-RT RIC 1712 provides a query-able catalog for an ML designer/developer to publish/install trained ML models (e.g., executable software components). In these implementations, the non-RT RIC 1712 may provide discovery mechanism if a particular ML model can be executed in a target ML inference host (MF), and what number and type of ML models can be executed in the MF. For example, there may be three types of ML catalogs made discoverable by the non-RT RIC 1712: a design-time catalog (e.g., residing outside the non-RT RIC 1712 and hosted by some other ML platform(s)), a training/deployment-time catalog (e.g., residing inside the non-RT RIC 1712), and a run-time catalog (e.g., residing inside the non-RT RIC 1712). The non-RT RIC 1712 supports necessary capabilities for ML model inference in support of ML assisted solutions running in the non-RT RIC 1712 or some other ML inference host. These capabilities enable executable software to be installed such as VMs, containers, etc. The non-RT RIC 1712 may also include and/or operate one or more ML engines, which are packaged software executable libraries that provide methods, routines, data types, etc., used to run ML models. The non-RT RIC 1712 may also implement policies to switch and activate ML model instances under different operating conditions.

The non-RT RIC 1712 is be able to access feedback data (e.g., FM and PM statistics) over the O1 interface on ML model performance and perform necessary evaluations. If the ML model fails during runtime, an alarm can be generated as feedback to the non-RT RIC 1712. How well the ML model is performing in terms of prediction accuracy or other operating statistics it produces can also be sent to the non-RT RIC 1712 over 01. The non-RT RIC 1712 can also scale ML model instances running in a target MF over the O1 interface by observing resource utilization in MF. The environment where the ML model instance is running (e.g., the MF) monitors resource utilization of the running ML model. This can be done, for example, using an ORAN-SC component called ResourceMonitor in the near-RT RIC 1714 and/or in the non-RT RIC 1712, which continuously monitors resource utilization. If resources are low or fall below a certain threshold, the runtime environment in the near-RT RIC 1714 and/or the non-RT RIC 1712 provides a scaling mechanism to add more ML instances. The scaling mechanism may include a scaling factor such as an number, percentage, and/or other like data used to scale up/down the number of ML instances. ML model instances running in the target ML inference hosts may be automatically scaled by observing resource utilization in the MF. For example, the Kubernetes® (K8s) runtime environment typically provides an auto-scaling feature.

The A1 interface is between the non-RT RIC 1712 (within or outside the SMO 1702) and the near-RT RIC 1714. The A1 interface supports three types of services as defined in [O14], including a Policy Management Service, an Enrichment Information Service, and ML Model Management Service. A1 policies have the following characteristics compared to persistent configuration [O14]: A1 policies are not critical to traffic; A1 policies have temporary validity; A1 policies may handle individual UE or dynamically defined groups of UEs; A1 policies act within and take precedence over the configuration; and A1 policies are non-persistent, i.e., do not survive a restart of the near-RT RIC.

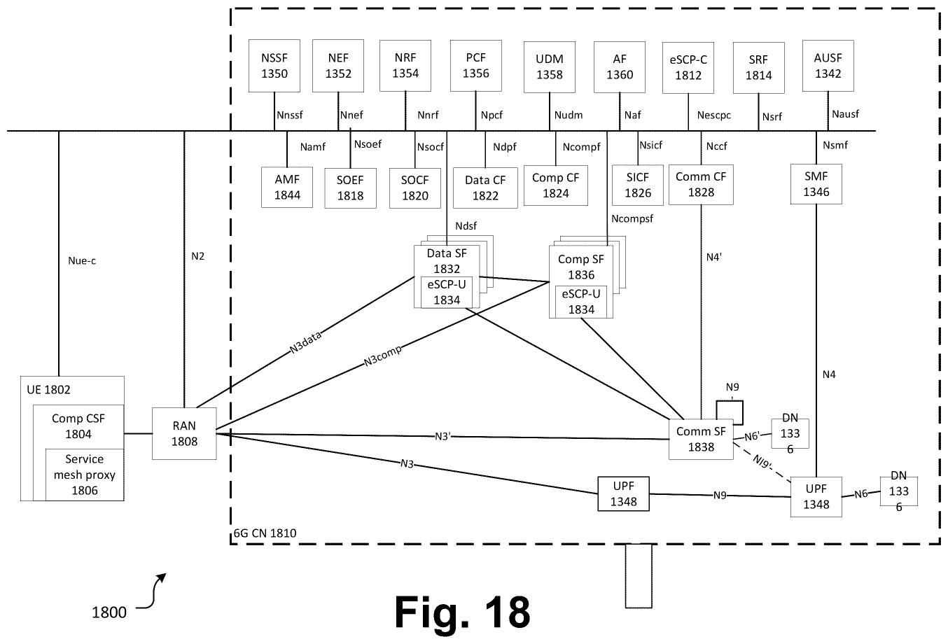

FIG. 18 illustrates a network 1800 in accordance with various embodiments. The network 1800 may operate in a matter consistent with 3GPP technical specifications or technical reports for 6G systems. In some embodiments, the network 1800 may operate concurrently with network 1300. For example, in some embodiments, the network 1800 may share one or more frequency or bandwidth resources with network 1300. As one specific example, a UE (e.g., UE 1802) may be configured to operate in both network 1800 and network 1300. Such configuration may be based on a UE including circuitry configured for communication with frequency and bandwidth resources of both networks 1300 and 1800. In general, several elements of network 1800 may share one or more characteristics with elements of network 1300. For the sake of brevity and clarity, such elements may not be repeated in the description of network 1800.

The network 1800 may include a UE 1802, which may include any mobile or non-mobile computing device designed to communicate with a RAN 1808 via an over-the-air connection. The UE 1802 may be similar to, for example, UE 1302. The UE 1802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 18, in some embodiments the network 1800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 18, the UE 1802 may be communicatively coupled with an AP such as AP 1306 as described with respect to Fig. YX. Additionally, although not specifically shown in FIG. 18, in some embodiments the RAN 1808 may include one or more ANss such as AN 1308 as described with respect to Fig. YX. The RAN 1808 and/or the AN of the RAN 1808 may be referred to as a base station (BS), a RAN node, or using some other term or name.

The UE 1802 and the RAN 1808 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1808 may allow for communication between the UE 1802 and a 6G core network (CN) 1810. Specifically, the RAN 1808 may facilitate the transmission and reception of data between the UE 1802 and the 6G CN 1810. The 6G CN 1810 may include various functions such as NSSF 1350, NEF 1352, NRF 1354, PCF 1356, UDM 1358, AF 1360, SMF 1346, and AUSF 1342. The 6G CN 1810 may additional include UPF 1348 and DN 1336 as shown in FIG. 18.

Additionally, the RAN 1808 may include various additional functions that are in addition to, or alternative to, functions of a legacy cellular network such as a 4G or 5G network. Two such functions may include a Compute Control Function (Comp CF) 1824 and a Compute Service Function (Comp SF) 1836. The Comp CF 1824 and the Comp SF 1836 may be parts or functions of the Computing Service Plane. Comp CF 1824 may be a control plane function that provides functionalities such as management of the Comp SF 1836, computing task context generation and management (e.g., create, read, modify, delete), interaction with the underlying computing infrastructure for computing resource management, etc., Comp SF 1836 may be a user plane function that serves as the gateway to interface computing service users (such as UE 1802) and computing nodes behind a Comp SF instance. Some functionalities of the Comp SF 1836 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1836 instance may serve as the user plane gateway for a cluster of computing nodes. A Comp CF 1824 instance may control one or more Comp SF 1836 instances.

Two other such functions may include a Communication Control Function (Comm CF) 1828 and a Communication Service Function (Comm SF) 1838, which may be parts of the Communication Service Plane. The Comm CF 1828 may be the control plane function for managing the Comm SF 1838, communication sessions creation/configuration/releasing, and managing communication session context. The Comm SF 1838 may be a user plane function for data transport. Comm CF 1828 and Comm SF 1838 may be considered as upgrades of SMF 1346 and UPF 1348, which were described with respect to a 5G system in Fig. YX. The upgrades provided by the Comm CF 1828 and the Comm SF 1838 may enable service-aware transport. For legacy (e.g., 4G or 5G) data transport, SMF 1346 and UPF 1348 may still be used.

Two other such functions may include a Data Control Function (Data CF) 1822 and Data Service Function (Data SF) 1832 may be parts of the Data Service Plane. Data CF 1822 may be a control plane function and provides functionalities such as Data SF 1832 management, Data service creation/configuration/releasing, Data service context management, etc. Data SF 1832 may be a user plane function and serve as the gateway between data service users (such as UE 1802 and the various functions of the 6G CN 1810) and data service endpoints behind the gateway. Specific functionalities may include: parse data service user data and forward to corresponding data service endpoints, generate charging data, report data service status.

Another such function may be the Service Orchestration and Chaining Function (SOCF) 1820, which may discover, orchestrate and chain up communication/computing/data services provided by functions in the network. Upon receiving service requests from users, SOCF 1820 may interact with one or more of Comp CF 1824, Comm CF 1828, and Data CF 1822 to identify Comp SF 1836, Comm SF 1838, and Data SF 1832 instances, configure service resources, and generate the service chain, which could contain multiple Comp SF 1836, Comm SF 1838, and Data SF 1832 instances and their associated computing endpoints. Workload processing and data movement may then be conducted within the generated service chain. The SOCF 1820 may also responsible for maintaining, updating, and releasing a created service chain.

Another such function may be the service registration function (SRF) 1814, which may act as a registry for system services provided in the user plane such as services provided by service endpoints behind Comp SF 1836 and Data SF 1832 gateways and services provided by the UE 1802. The SRF 1814 may be considered a counterpart of NRF 1354, which may act as the registry for network functions.

Other such functions may include an evolved service communication proxy (eSCP) and service infrastructure control function (SICF) 1826, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1812 and eSCP-U 1834, for control plane service communication proxy and user plane service communication proxy, respectively. The SICF 1826 may control and configure eCSP instances in terms of service traffic routing policies, access rules, load balancing configurations, performance monitoring, etc.

Another such function is the AMF 1844. The AMF 1844 may be similar to 1344, but with additional functionality. Specifically, the AMF 1844 may include potential functional repartition, such as move the message forwarding functionality from the AMF 1844 to the RAN 1808.

Another such function is the service orchestration exposure function (SOEF) 1818. The SOEF may be configured to expose service orchestration and chaining services to external users such as applications.

The UE 1802 may include an additional function that is referred to as a computing client service function (comp CSF) 1804. The comp CSF 1804 may have both the control plane functionalities and user plane functionalities, and may interact with corresponding network side functions such as SOCF 1820, Comp CF 1824, Comp SF 1836, Data CF 1822, and/or Data SF 1832 for service discovery, request/response, compute task workload exchange, etc. The Comp CSF 1804 may also work with network side functions to decide on whether a computing task should be run on the UE 1802, the RAN 1808, and/or an element of the 6G CN 1810.

The UE 1802 and/or the Comp CSF 1804 may include a service mesh proxy 1806. The service mesh proxy 1806 may act as a proxy for service-to-service communication in the user plane. Capabilities of the service mesh proxy 1806 may include one or more of addressing, security, load balancing, etc.

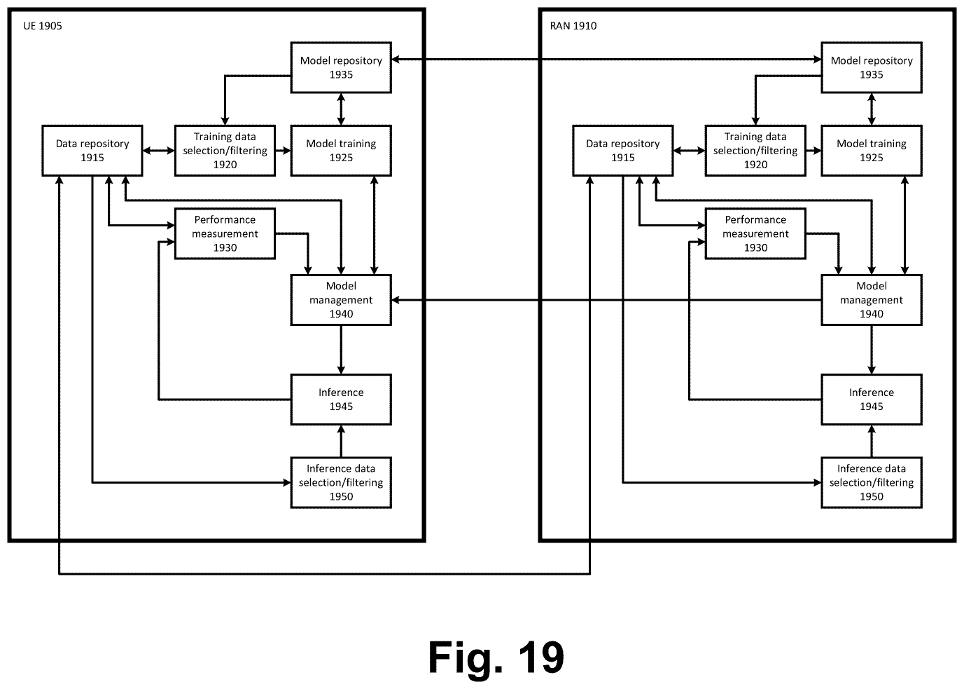

FIG. 19 illustrates a simplified block diagram of artificial (AI)-assisted communication between a UE 1905 and a RAN 1910, in accordance with various embodiments. More specifically, as described in further detail below, AI/machine learning (ML) models may be used or leveraged to facilitate over-the-air communication between UE 1905 and RAN 1910.

One or both of the UE 1905 and the RAN 1910 may operate in a matter consistent with 3GPP technical specifications or technical reports for 6G systems. In some embodiments, the wireless cellular communication between the UE 1905 and the RAN 1910 may be part of, or operate concurrently with, networks 1800, 1300, and/or some other network described herein.

The UE 1905 may be similar to, and share one or more features with, UE 1802, UE 1302, and/or some other UE described herein. The UE 1905 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 1910 may be similar to, and share one or more features with, RAN 1314, RAN 1808, and/or some other RAN described herein.

As may be seen in FIG. 19, the AI-related elements of UE 1905 may be similar to the AI-related elements of RAN 1910. For the sake of discussion herein, description of the various elements will be provided from the point of view of the UE 1905, however it will be understood that such discussion or description will apply to equally named/numbered elements of RAN 1910, unless explicitly stated otherwise.

As previously noted, the UE 1905 may include various elements or functions that are related to AI/ML. Such elements may be implemented as hardware, software, firmware, and/or some combination thereof. In embodiments, one or more of the elements may be implemented as part of the same hardware (e.g., chip or multi-processor chip), software (e.g., a computing program), or firmware as another element.

One such element may be a data repository 1915. The data repository 1915 may be responsible for data collection and storage. Specifically, the data repository 1915 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 1915. For example, as may be seen, the inference data selection/filter element 1950 may retrieve data from the data repository 1915. In various embodiments, the UE 1905 may be configured to discover and request data from the data repository 1915 in the RAN, and vice versa. More generally, the data repository 1915 of the UE 1905 may be communicatively coupled with the data repository 1915 of the RAN 1910 such that the respective data repositories of the UE and the RAN may share collected data with one another.

Another such element may be a training data selection/filtering functional block 1920. The training data selection/filter functional block 1920 may be configured to generate training, validation, and testing datasets for model training. Training data may be extracted from the data repository 1915. Data may be selected/filtered based on the specific AI/ML model to be trained. Data may optionally be transformed/augmented/pre-processed (e.g., normalized) before being loaded into datasets. The training data selection/filter functional block 1920 may label data in datasets for supervised learning. The produced datasets may then be fed into model training the model training functional block 1925.

As noted above, another such element may be the model training functional block 1925. This functional block may be responsible for training and updating (re-training) AI/ML models. The selected model may be trained using the fed-in datasets (including training, validation, testing) from the training data selection/filtering functional block. The model training functional block 1925 may produce trained and tested AI/ML models which are ready for deployment. The produced trained and tested models can be stored in a model repository 1935.

The model repository 1935 may be responsible for AI/ML models' (both trained and un-trained) storage and exposure. Trained/updated model(s) may be stored into the model repository 1935. Model and model parameters may be discovered and requested by other functional blocks (e.g., the training data selection/filter functional block 1920 and/or the model training functional block 1925). In some embodiments, the UE 1905 may discover and request AI/ML models from the model repository 1935 of the RAN 1910. Similarly, the RAN 1910 may be able to discover and/or request AI/ML models from the model repository 1935 of the UE 1905. In some embodiments, the RAN 1910 may configure models and/or model parameters in the model repository 1935 of the UE 1905.

Another such element may be a model management functional block 1940. The model management functional block 1940 may be responsible for management of the AI/ML model produced by the model training functional block 1925. Such management functions may include deployment of a trained model, monitoring model performance, etc. In model deployment, the model management functional block 1940 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 1940 may decide to terminate the running model, start model re-training, select another model, etc. In embodiments, the model management functional block 1940 of the RAN 1910 may be able to configure model management policies in the UE 1905 as shown.

Another such element may be an inference data selection/filtering functional block 1950. The inference data selection/filter functional block 1950 may be responsible for generating datasets for model inference at the inference functional block 1945, as described below. Specifically, inference data may be extracted from the data repository 1915. The inference data selection/filter functional block 1950 may select and/or filter the data based on the deployed AI/ML model. Data may be transformed/augmented/pre-processed following the same transformation/augmentation/pre-processing as those in training data selection/filtering as described with respect to functional block 1920. The produced inference dataset may be fed into the inference functional block 1945.

Another such element may be the inference functional block 1945. The inference functional block 1945 may be responsible for executing inference as described above. Specifically, the inference functional block 1945 may consume the inference dataset provided by the inference data selection/filtering functional block 1950, and generate one or more outcomes. Such outcomes may be or include data analytics, actions, policies, etc. The outcome(s) may be provided to the performance measurement functional block 1930.

The performance measurement functional block 1930 may be configured to measure model performance metrics (e.g., accuracy, model bias, run-time latency, etc.) of deployed and executing models based on the inference outcome(s) for monitoring purpose. Model performance data may be stored in the data repository 1915.

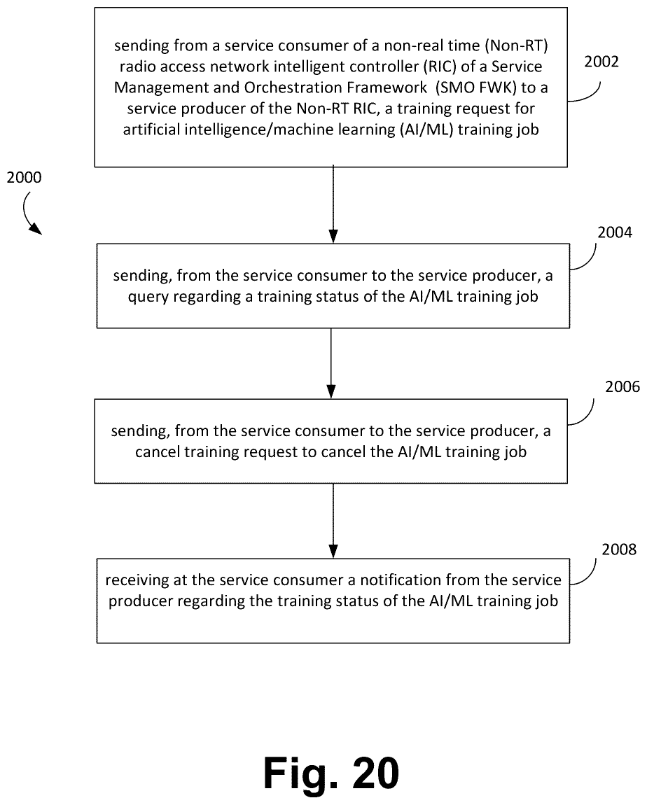

FIG. 20 illustrates a method 2000 according to a first embodiment. Method 2000 includes, at operation 2002, sending from a service consumer of a non-real time (Non-RT) radio access network intelligent controller (RIC) of a Service Management and Orchestration Framework (SMO FW) to a service producer of the Non-RT RIC, wherein the service consumer corresponds to one of a non-RT RIC application (rApp) of the non-RT RIC, or to an entity of a Non-RT RIC framework (Non-RT RIC FWK) of the non-RT RIC, a training request for artificial intelligence/machine learning (AI/ML) training job; at operation 2004, sending, from the service consumer to the service producer, a query regarding a training status of the AI/ML training job; at operation 2006, sending, from the service consumer to the service producer, a cancel training request to cancel the AI/ML training job; and at operation 2008, receiving at the service consumer a notification from the service producer regarding the training status of the AI/ML training job.

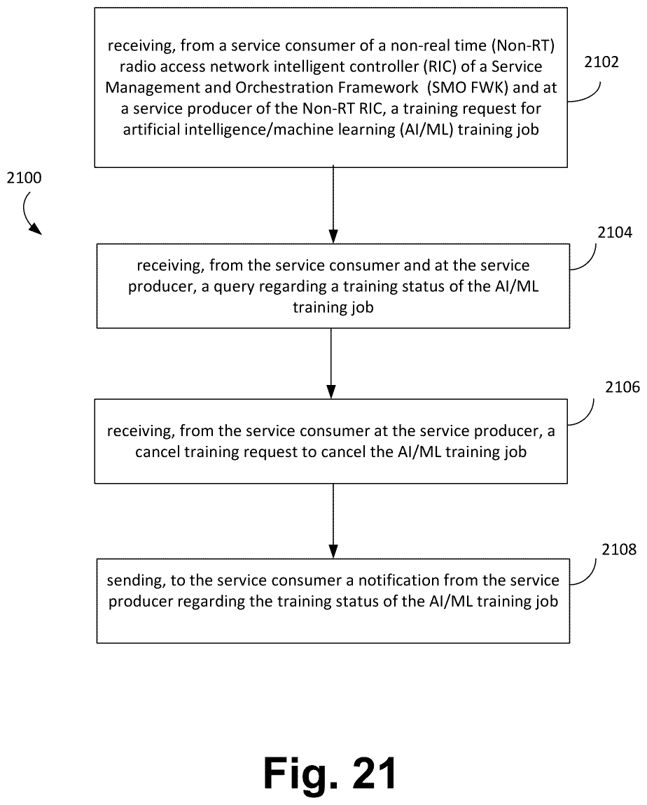

FIG. 21 illustrates a method according to a second embodiment. Method 2100 includes, at operation 2102, receiving, from a service consumer of a non-real time (Non-RT) radio access network intelligent controller (RIC) of a Service Management and Orchestration Framework (SMO FW) and at a service producer of the Non-RT RIC, wherein the service consumer corresponds to one of a non-RT RIC application (rApp) of the non-RT RIC, or to an entity of a Non-RT RIC framework (Non-RT RIC FWK) of the non-RT RIC, a training request for artificial intelligence/machine learning (AI/ML) training job; at operation 2104, receiving, from the service consumer and at the service producer, a query regarding a training status of the AI/ML training job; at operation 2106, receiving, from the service consumer at the service producer, a cancel training request to cancel the AI/ML training job; and at operation 2108, sending, to the service consumer a notification from the service producer regarding the training status of the AI/ML training job.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 includes a non-transitory machine-readable storage-medium storing instructions that correspond to a service consumer of a non-real-time (non-RT) radio access network intelligent controller (RIC) of a Service Management and Orchestration Framework (SMO FW), wherein the service consumer corresponds to one of a non-RT RIC application (rApp) of the non-RT RIC, or to an entity of a Non-RT RIC framework (Non-RT RIC FWK) of the non-RT RIC, the instructions to cause one or more processors, upon execution of the instructions, to perform operations including: sending, to a service producer of the non-RT RIC, a training request for artificial intelligence/machine learning (AI/ML) training job; sending, to the service producer, a query regarding a training status of the AI/ML training job; sending, to the service producer, a cancel training request to cancel the AI/ML training job; and receiving a notification from the service producer regarding the training status of the AI/ML training job.

Example 2 includes the subject matter of Example 1, the operations further including: receiving a request training response from the service producer in response to the training request, the request training response including an indication of acceptance of the training request; receiving a query response from the service producer in response to the query, the query response including information regarding the training status of the AI/ML training job; and receiving a request to cancel training response in response to cancel training request, cancel training request response including an indication of a cancellation of the AI/ML training job.

Example 3 includes the subject matter of Example 2, wherein the request training response includes a training job identification (training job id) for the AI/ML training job.

Example 4 includes the subject matter of Example any one of claims 1-3, wherein the training status includes one of: an indication that the AI/ML has been completed; an indication that the AI/ML is in process; an indication that the AI/ML is on hold; an indication that the AI/ML has been aborted; an indication that the AI/ML has timed out; or an indication that the AI/ML has been cancelled.

Example 5 includes the subject matter of any one of Examples 1-4, wherein the training request includes information regarding an rApp identification (rApp id), required training data for the AI/ML training job, model access details to retrieve a model for the AI/ML training job from a model repository, and a call-back uniform resource identifier (URI) to receive training status notifications for the AI/ML training job.

Example 6 includes the subject matter of Example 5, wherein the training request further includes at least one of information about training criteria for the AI/ML training job, a maximum number of epochs for the AI/ML training job, or a maximum training time for the AI/ML training job.

Example 7 includes the subject matter of any one of Examples 1-6, wherein the query includes an rApp identification (rApp id) and a training job identification (training job id) for the AI/ML training job.

Example 8 includes the subject matter of any one of Examples 1-7, wherein the notification includes a training job identification (training job id) for the AI/ML training job, a training status of the AI/ML training job, and trained model access details to retrieve a trained model for the AI/ML training job from a model repository.

Example 9 includes the subject matter of any one of Examples 1-8, wherein the service producer corresponds to AI/ML training functions of a Non-RT RIC framework of the Non-RT RIC.

Example 10 includes the subject matter of any one of Examples 1-8, wherein the rApp corresponds to a first rApp of the non-RT RIC, and the service producer corresponds to a second rApp of the non-RT RIC.

Example 11 includes the subject matter of Example 2, wherein: sending the training request includes implementing a HyperText Transport Protocol (HTTP) POST method; sending the query includes implementing an HTTP GET method; and sending cancel training request the AI/ML training job includes implementing an HTTP DELETE method.

Example 12 includes the subject matter of Example 11, wherein: receiving the request training response is to be based on an HTTP 201 Created status code; receiving a query response is to be based on an HTTP 200 OK status code; receiving cancel training request is based on an HTTP 204 No Content status code; and receiving the notification is based on an HTTP POST method.

Example 13 includes an apparatus to host a service consumer of a non-real-time (non-RT) radio access network intelligent controller (RIC) of a Service Management and Orchestration Framework (SMO FW), wherein the service consumer corresponds to one of a non-RT RIC application (rApp) of the non-RT RIC, or to an entity of a Non-RT RIC framework (Non-RT RIC FWK) of the non-RT RIC, the apparatus including a memory, and one or more processors coupled to the memory to: send, to a service producer of the non-RT RIC, a training request for artificial intelligence/machine learning (AI/ML) training job; send, to the service producer, a query regarding a training status of the AI/ML training job; send, to the service producer, a cancel training request to cancel the AI/ML training job; and receive a notification from the service producer regarding the training status of the AI/ML training job.

Example 14 includes the subject matter of Example 13, the one or more processors to further: receiving a request training response from the service producer in response to the training request, the request training response including an indication of acceptance of the training request; receiving a query response from the service producer in response to the query, the query response including information regarding the training status of the AI/ML training job; and receiving a request to cancel training response in response to cancel training request, cancel training request response including an indication of a cancellation of the AI/ML training job.

Example 15 includes the subject matter of Example 14, wherein the request training response includes a training job identification (training job id) for the AI/ML training job.

Example 16 includes the subject matter of Example any one of claims 13-15, wherein the training status includes one of: an indication that the AI/ML has been completed; an indication that the AI/ML is in process; an indication that the AI/ML is on hold; an indication that the AI/ML has been aborted; an indication that the AI/ML has timed out; or an indication that the AI/ML has been cancelled.

Example 17 includes the subject matter of any one of Examples 13-16, wherein the training request includes information regarding an rApp identification (rApp id), required training data for the AI/ML training job, model access details to retrieve a model for the AI/ML training job from a model repository, and a call-back uniform resource identifier (URI) to receive training status notifications for the AI/ML training job.

Example 18 includes the subject matter of Example 17, wherein the training request further includes at least one of information about training criteria for the AI/ML training job, a maximum number of epochs for the AI/ML training job, or a maximum training time for the AI/ML training job.

Example 19 includes the subject matter of any one of Examples 13-18, wherein the query includes an rApp identification (rApp id) and a training job identification (training job id) for the AI/ML training job.

Example 20 includes the subject matter of any one of Examples 13-19, wherein the notification includes a training job identification (training job id) for the AI/ML training job, a training status of the AI/ML training job, and trained model access details to retrieve a trained model for the AI/ML training job from a model repository.

Example 21 includes the subject matter of any one of Examples 13-20, wherein the service producer corresponds to AI/ML training functions of a Non-RT RIC framework of the Non-RT RIC.

Example 22 includes the subject matter of any one of Examples 13-20, wherein the rApp corresponds to a first rApp of the non-RT RIC, and the service producer corresponds to a second rApp of the non-RT RIC.

Example 23 includes the subject matter of Example 14, wherein: sending the training request includes implementing a HyperText Transport Protocol (HTTP) POST method; sending the query includes implementing an HTTP GET method; and sending cancel training request the AI/ML training job includes implementing an HTTP DELETE method.

Example 24 includes the subject matter of Example 23, wherein: receiving the request training response is to be based on an HTTP 201 Created status code; receiving a query response is to be based on an HTTP 200 OK status code; receiving cancel training request is based on an HTTP 204 No Content status code; and receiving the notification is based on an HTTP POST method.

Example 25 includes the subject matter of any one of Examples 13-24, further including a functional interface to an R1 termination entity of a non-RT RIC framework of the non-RT RIC.

Example 26 includes the subject matter of Example 25, further including the R1 termination entity.

Example 27 includes a method to be performed at a service consumer of a non-real-time (non-RT) radio access network intelligent controller (RIC) of a Service Management and Orchestration Framework (SMO FW), wherein the service consumer corresponds to one of a non-RT RIC application (rApp) of the non-RT RIC, or to an entity of a Non-RT RIC framework (Non-RT RIC FWK) of the non-RT RIC, the method including: sending, to a service producer of the non-RT RIC, a training request for artificial intelligence/machine learning (AI/ML) training job; sending, to the service producer, a query regarding a training status of the AI/ML training job; sending, to the service producer, a cancel training request to cancel the AI/ML training job; and receiving a notification from the service producer regarding the training status of the AI/ML training job.

Example 28 includes the subject matter of Example 27, the method further including: receiving a request training response from the service producer in response to the training request, the request training response including an indication of acceptance of the training request; receiving a query response from the service producer in response to the query, the query response including information regarding the training status of the AI/ML training job; and receiving a request to cancel training response in response to cancel training request, cancel training request response including an indication of a cancellation of the AI/ML training job.

Example 29 includes the subject matter of Example 28, wherein the request training response includes a training job identification (training job id) for the AI/ML training job.

Example 30 includes the subject matter of Example any one of claims 27-29, wherein the training status includes one of: an indication that the AI/ML has been completed; an indication that the AI/ML is in process; an indication that the AI/ML is on hold; an indication that the AI/ML has been aborted; an indication that the AI/ML has timed out; or an indication that the AI/ML has been cancelled.

Example 31 includes the subject matter of any one of Examples 27-30, wherein the training request includes information regarding an rApp identification (rApp id), required training data for the AI/ML training job, model access details to retrieve a model for the AI/ML training job from a model repository, and a call-back uniform resource identifier (URI) to receive training status notifications for the AI/ML training job.

Example 32 includes the subject matter of Example 31, wherein the training request further includes at least one of information about training criteria for the AI/ML training job, a maximum number of epochs for the AI/ML training job, or a maximum training time for the AI/ML training job.

Example 33 includes the subject matter of any one of Examples 27-32, wherein the query includes a rApp identification (rApp id) and a training job identification (training job id) for the AI/ML training job.

Example 34 includes the subject matter of any one of Examples 27-33, wherein the notification includes a training job identification (training job id) for the AI/ML training job, a training status of the AI/ML training job, and trained model access details to retrieve a trained model for the AI/ML training job from a model repository.

Example 35 includes the subject matter of any one of Examples 27-34, wherein the service producer corresponds to AI/ML training functions of a Non-RT RIC framework of the Non-RT RIC.

Example 36 includes the subject matter of any one of Examples 27-34, wherein the rApp corresponds to a first rApp of the non-RT RIC, and the service producer corresponds to a second rApp of the non-RT RIC.

Example 37 includes the subject matter of any one of Example 28, wherein: sending the training request includes implementing a HyperText Transport Protocol (HTTP) POST method; sending the query includes implementing an HTTP GET method; and sending cancel training request the AI/ML training job includes implementing an HTTP DELETE method.

Example 38 includes the subject matter of Example 37, wherein: receiving the request training response is to be based on an HTTP 201 Created status code; receiving a query response is to be based on an HTTP 200 OK status code; receiving cancel training request is based on an HTTP 204 No Content status code; and receiving the notification is based on an HTTP POST method.

Example 39 includes a non-transitory machine-readable storage-medium storing instructions that correspond to a service producer of a non-real-time (non-RT) radio access network intelligent controller (RIC) of a Service Management and Orchestration Framework (SMO FW), the instructions to cause one or more processors, upon execution of the instructions, to perform operations including: receiving, from a service consumer of the non-RT RIC, a training request for artificial intelligence/machine learning (AI/ML) training job, wherein the service consumer corresponds to one of a non-RT RIC application (rApp) of the non-RT RIC, or to an entity of a Non-RT RIC framework (Non-RT RIC FWK) of the non-RT RIC; receiving, from the service consumer, a query regarding a training status of the AI/ML training job; receiving, from the service consumer, a cancel training request to cancel the AI/ML training job; and sending a notification to the service consumer regarding the training status of the AI/ML training job.

Example 40 includes the subject matter of Example 39, the operations further including: sending a request training response to the service consumer in response to the training request, the request training response including an indication of acceptance of the training request; sending a query response to the service consumer in response to the query, the query response including information regarding the training status of the AI/ML training job; and sending a request to cancel training response in response to cancel training request, cancel training request response including an indication of a cancellation of the AI/ML training job.

Example 41 includes the subject matter of Example 40, wherein the request training response includes a training job identification (training job id) for the AI/ML training job.

Example 42 includes the subject matter of Example any one of claims 39-41, wherein the training status includes one of: an indication that the AI/ML has been completed; an indication that the AI/ML is in process; an indication that the AI/ML is on hold; an indication that the AI/ML has been aborted; an indication that the AI/ML has timed out; or an indication that the AI/ML has been cancelled.

Example 43 includes the subject matter of any one of Examples 39-42, wherein the training request includes information regarding an rApp identification (rApp id), required training data for the AI/ML training job, model access details to retrieve a model for the AI/ML training job from a model repository, and a call-back uniform resource identifier (URI) to receive training status notifications for the AI/ML training job.

Example 44 includes the subject matter of Example 43, wherein the training request further includes at least one of information about training criteria for the AI/ML training job, a maximum number of epochs for the AI/ML training job, or a maximum training time for the AI/ML training job.

Example 45 includes the subject matter of any one of Examples 39-44, wherein the query includes an rApp identification (rApp id) and a training job identification (training job id) for the AI/ML training job.

Example 46 includes the subject matter of any one of Examples 39-45, wherein the notification includes a training job identification (training job id) for the AI/ML training job, a training status of the AI/ML training job, and trained model access details to retrieve a trained model for the AI/ML training job from a model repository.

Example 47 includes the subject matter of any one of Examples 39-46, wherein the service producer corresponds to AI/ML training job functions of a Non-RT RIC framework of the Non-RT RIC.

Example 48 includes the subject matter of any one of Examples 39-46, wherein the rApp corresponds to a first rApp of the non-RT RIC, and the service producer corresponds to a second rApp of the non-RT RIC.

Example 49 includes the subject matter of any one of Examples 40, wherein: receiving the training request includes implementing a HyperText Transport Protocol (HTTP) POST method; receiving the query includes implementing an HTTP GET method; and receiving cancel training request the AI/ML training job includes implementing an HTTP DELETE method.

Example 50 includes the subject matter of Example 49, wherein: sending the request training response includes using an HTTP 201 Created status code; sending a query response includes using an HTTP 200 OK status code; sending cancel training request includes using an HTTP 204 No Content status code; and sending the notification includes implementing an HTTP POST method.

Example 51 includes the subject matter of Example 40, the operations further including, after sending the request training response: retrieving a model for the AI/ML training job from a model repository of a non-RT RIC framework (FW) of the non-RT RIC; performing data consumption for training data; and performing the AI/ML training job.

Example 52 includes the subject matter of Example 40, the operations further including, after receiving the cancel training request, terminating the AI/ML training job.

Example 53 includes the subject matter of Example 40, the operations further including sending the notification in response to a change in the AI/ML training job and to storing a model.

Example 54 includes an apparatus to host a service producer of a non-real-time (non-RT) radio access network intelligent controller (RIC) of a Service Management and Orchestration Framework (SMO FW), the apparatus including a memory, and one or more processors coupled to the memory to: receive, from a service consumer of the non-RT RIC, a training request for artificial intelligence/machine learning (AI/ML) training job, wherein the service consumer corresponds to one of a non-RT RIC application (rApp) of the non-RT RIC, or to an entity of a Non-RT RIC framework (Non-RT RIC FWK) of the non-RT RIC; receive, from the service consumer, a query regarding a training status of the AI/ML training job; receive, from the service consumer, a cancel training request to cancel the AI/ML training job; and send a notification to the service consumer regarding the training status of the AI/ML training job.

Example 55 includes the subject matter of Example 54, the one or more processors to further: send a request training response to the service consumer in response to the training request, the request training response including an indication of acceptance of the training request; send a query response to the service consumer in response to the query, the query response including information regarding the training status of the AI/ML training job; and send a request to cancel training response in response to cancel training request, cancel training request response including an indication of a cancellation of the AI/ML training job.

Example 56 includes the subject matter of Example 55, wherein the request training response includes a training job identification (training job id) for the AI/ML training job.

Example 57 includes the subject matter of Example any one of claims 54-56, wherein the training status includes one of: an indication that the AI/ML has been completed; an indication that the AI/ML is in process; an indication that the AI/ML is on hold; an indication that the AI/ML has been aborted; an indication that the AI/ML has timed out; or an indication that the AI/ML has been cancelled.

Example 58 includes the subject matter of any one of Examples 54-57, wherein the training request includes information regarding an rApp identification (rApp id), required training data for the AI/ML training job, model access details to retrieve a model for the AI/ML training job from a model repository, and a call-back uniform resource identifier (URI) to receive training status notifications for the AI/ML training job.

Example 59 includes the subject matter of Example 58, wherein the training request further includes at least one of information about training criteria for the AI/ML training job, a maximum number of epochs for the AI/ML training job, or a maximum training time for the AI/ML training job.

Example 60 includes the subject matter of any one of Examples 54-59, wherein the query includes an rApp identification (rApp id) and a training job identification (training job id) for the AI/ML training job.

Example 61 includes the subject matter of any one of Examples 54-60, wherein the notification includes a training job identification (training job id) for the AI/ML training job, a training status of the AI/ML training job, and trained model access details to retrieve a trained model for the AI/ML training job from a model repository.

Example 62 includes the subject matter of any one of Examples 54-61, wherein the service producer corresponds to AI/ML training functions of a Non-RT RIC framework of the Non-RT RIC.

Example 63 includes the subject matter of any one of Examples 54-61, wherein the rApp corresponds to a first rApp of the non-RT RIC, and the service producer corresponds to a second rApp of the non-RT RIC.

Example 64 includes the subject matter of any one of Examples 55, wherein: receiving the training request includes implementing a HyperText Transport Protocol (HTTP) POST method; receiving the query includes implementing an HTTP GET method; and receiving cancel training request the AI/ML training job includes implementing an HTTP DELETE method.

Example 65 includes the subject matter of Example 64, wherein: sending the request training response includes using an HTTP 201 Created status code; sending a query response includes using an HTTP 200 OK status code; sending cancel training request includes using an HTTP 204 No Content status code; and sending the notification includes implementing an HTTP POST method.

Example 66 includes the subject matter of Example 65, the one or more processors to further, after sending the request training response: retrieve a model for the AI/ML training job from a model repository of a non-RT RIC framework (FW) of the non-RT RIC; perform data consumption for training data; and perform the AI/ML training job.

Example 67 includes the subject matter of Example 55, the one or more processors to further, after receiving the cancel training request, terminate the AI/ML training job.

Example 68 includes the subject matter of Example 55, the one or more processors to further send the notification in response to a change in the AI/ML training job and to storing a model.

Example 69 includes the subject matter of any one of Examples 54-68, further including a functional interface to an R1 termination entity of a non-RT RIC framework of the non-RT RIC.

Example 70 includes the subject matter of Example 69, further including the R1 termination entity.

Example 71 includes a method to be performed at a service producer of a non-real-time (non-RT) radio access network intelligent controller (RIC) of a Service Management and Orchestration Framework (SMO FW), the method including: receiving, from a service consumer of the non-RT RIC, a training request for artificial intelligence/machine learning (AI/ML) training job, wherein the service consumer corresponds to one of a non-RT RIC application (rApp) of the non-RT RIC, or to an entity of a Non-RT RIC framework (Non-RT RIC FWK) of the non-RT RIC; receiving, from the service consumer, a query regarding a training status of the AI/ML training job; receiving, from the service consumer, a cancel training request to cancel the AI/ML training job; and sending a notification to the service consumer regarding the training status of the AI/ML training job.

Example 72 includes the subject matter of Example 71, the method further including: sending a request training response to the service consumer in response to the training request, the request training response including an indication of acceptance of the training request; sending a query response to the service consumer in response to the query, the query response including information regarding the training status of the AI/ML training job; and sending a request to cancel training response in response to cancel training request, cancel training request response including an indication of a cancellation of the AI/ML training job.

Example 73 includes the subject matter of Example 72, wherein the request training response includes a training job identification (training job id) for the AI/ML training job.

Example 74 includes the subject matter of Example any one of claims 71-73, wherein the training status includes one of: an indication that the AI/ML has been completed; an indication that the AI/ML is in process; an indication that the AI/ML is on hold; an indication that the AI/ML has been aborted; an indication that the AI/ML has timed out; or an indication that the AI/ML has been cancelled.

Example 75 includes the subject matter of any one of Examples 71-74, wherein the training request includes information regarding an rApp identification (rApp id), required training data for the AI/ML training job, model access details to retrieve a model for the AI/ML training job from a model repository, and a call-back uniform resource identifier (URI) to receive training status notifications for the AI/ML training job.

Example 76 includes the subject matter of Example 75, wherein the training request further includes at least one of information about training criteria for the AI/ML training job, a maximum number of epochs for the AI/ML training job, or a maximum training time for the AI/ML training job.

Example 77 includes the subject matter of any one of Examples 71-76, wherein the query includes an rApp identification (rApp id) and a training job identification (training job id) for the AI/ML training job.

Example 78 includes the subject matter of any one of Examples 71-77, wherein the notification includes a training job identification (training job id) for the AI/ML training job, a training status of the AI/ML training job, and trained model access details to retrieve a trained model for the AI/ML training job from a model repository.

Example 79 includes the subject matter of any one of Examples 71-78, wherein the service producer corresponds to AI/ML training functions of a Non-RT RIC framework of the Non-RT RIC.

Example 80 includes the subject matter of any one of Examples 71-78, wherein the rApp corresponds to a first rApp of the non-RT RIC, and the service producer corresponds to a second rApp of the non-RT RIC.

Example 81 includes the subject matter of any one of Examples 72, wherein: receiving the training request includes implementing a HyperText Transport Protocol (HTTP) POST method; receiving the query includes implementing an HTTP GET method; and receiving cancel training request the AI/ML training job includes implementing an HTTP DELETE method.

Example 82 includes the subject matter of Example 81, wherein: sending the request training response includes using an HTTP 201 Created status code; sending a query response includes using an HTTP 200 OK status code; sending cancel training request includes using an HTTP 204 No Content status code; and sending the notification includes implementing an HTTP POST method.

Example 83 includes the subject matter of Example 82, the method further including, after sending the request training response: retrieving a model for the AI/ML training job from a model repository of a non-RT RIC framework (FW) of the non-RT RIC; performing data consumption for training data; and performing the AI/ML training job.

Example 84 includes the subject matter of Example 72, the method further including, after receiving the cancel training request, terminating the AI/ML training job.

Example 85 includes the subject matter of Example 72, the method further including sending the notification in response to a change in the AI/ML training job and to storing a model.

Example 86 includes an apparatus including means for performing the method of any one of Examples 27-38 and 71-85.

Example A1 includes a method to provide service operations for the AI/ML training service in a Non-RT RIC including one or more of: Request training (create a training job); Query training status; Cancel training (stop a training job); or Notify training status.

Example A2 includes the method of Example A1 or some other example herein, wherein an end-to-end sequence diagram is proposed (as FIG. 6-2) to allow the training service consumer rApp to consume AI/ML training services in the Non-RT RIC. The training service producer can be either the AI/ML workflow functions in the Non-RT RIC framework or a training service producer rApp.

Example A3 includes the method of Example A1 or some other example herein, wherein use case workflows for request training (as FIG. 6-3), query training status (as FIG. 6-5), cancel training (as FIG. 6-7), and notify training status (as FIG. 6-9) are proposed

Example A4 includes the method of Example A1 or some other example herein, wherein request training service operation using HTTP POST method (as FIG. 6-4) is proposed. The service consumer sends HTTP POST request to the service producer, and the service producer sends HTTP POST response back to the service consumer.

Example A5 includes the method of Example A4 or some other example herein, wherein the data structure TrainingJobDescription is carried by the HTTP POST request message body, and includes information of the training data, information of model access details, URI where the notification should be delivered to, and, optionally: information on training criteria (e.g., validation criteria, etc.); rAppId of the training service consumer rApp; and rAppId of the training service producer rApp.

Example A6 includes the method of Example A5 or some other example herein, wherein the data type ModelAccessInfo is defined to provide information of model access details, including model identifier of the model to be trained, endpoint to obtain the model, and, optionally, version number of the model to be trained.

Example A7 includes in embodiment of Example A4 or some other example herein, wherein the data structure TrainingJobDescription is carried by the HTTP POST response message body as the representation of created training job. The “Location” header of the HTTP POST response contains trainingJobId as the URI of the created training job resource.

Example A8 includes the method of Example A1 or some other example herein, wherein query training status service operation using HTTP GET method (as FIG. 6-6) is proposed. The service consumer sends HTTP GET request to the service producer, and the service producer sends HTTP GET response back to the service consumer.

Example A9 includes the method of Example A8 or some other example herein, wherein the target URI contains trainingJobId as the identifier of the training job. The message body of HTTP GET request is empty

Example A10 includes the method of Example A8 or some other example herein, wherein the data structure TrainingStatusType is carried by the HTTP GET response message body providing the training status of the queried training job.

Example A11 includes the method of Example A10 or some other example herein, wherein the TrainingStatusType has the following enumerations: COMPLETED, indicating the training is successfully completed; IN_PROGRESS, indicating the training is not completed and it is ongoing; ON_HOLD, indicating the training is not completed and it is on hold by the training service producer; ABORTED, indicating the training job is stopped by the training service producer; TIME_OUT, indicating the training job is completed (e.g., reaching the maximum epochs) but failed to meet the training criteria; and CANCELLED, indicating the training job is stopped by the training service consumer.

Example A12 includes the method of Example A1 or some other example herein, wherein cancel training service operation using HTTP DELETE method as in FIG. 8 is proposed, where the service consumer sends HTTP DELETE request to the service producer, and the service producer sends HTTP DELETE response back to the service consumer.

Example A13 includes the method of Example A12 or some other example herein, wherein the target URI contains trainingJobId as the identifier of the training job, and wherein the message body of HTTP DELETE request is empty.

Example A14 includes the method of Example A12 or some other example herein, wherein the message body of HTTP DELETE response is empty.

Example A15 includes the method of Example A1 or some other example herein, wherein notify training status service operation using HTTP POST method as in FIG. 10 is proposed, and wherein the service producer sends HTTP POST request to the service consumer, and the service consumer sends HTTP POST response back to the service producer.

Example A16 includes the method of Example A15 or some other example herein, wherein the data structure TrainingStatusNotification is carried in the message body of HTTP POST request, and the target URI is the callback URI (notificationDestination) provided by the service consumer.

Example A17 includes the method of Example A16 or some other example herein, wherein the data type TrainingStatusNotification includes: training job identifier; and training status.

Example A18 includes the method of Example A15 or some other example herein, wherein the message body of HTTP POST response is empty.

Example A19 includes the method of Example A1 or some other example herein, wherein the resource URI structure is as proposed in FIG. 11.

Example A20 includes another embodiment of examples, the alternative resource URI structure is as proposed in FIG. 12, containing rAppId of service consumer rApp in the URI.

Example Z01 includes an apparatus comprising means to perform one or more elements of a method described in or related to any of examples A1-A20, or any other method or process described herein.

Example Z02 includes one or more non-transitory computer-readable media comprising instructions to cause an electronic device, upon execution of the instructions by one or more processors of the electronic device, to perform one or more elements of a method described in or related to any of examples A1-A20, or any other method or process described herein.

Example Z03 includes an apparatus comprising logic, modules, or circuitry to perform one or more elements of a method described in or related to any of Examples A1-A20, or any other method or process described herein.

Example Z04 includes a method, technique, or process as described in or related to any of Examples A1-A20, or portions or parts thereof.

Example Z05 includes an apparatus comprising: one or more processors and one or more computer-readable media comprising instructions that, when executed by the one or more processors, cause the one or more processors to perform the method, techniques, or process as described in or related to any of Examples A1-A20, or portions thereof.

Example Z06 includes a signal as described in or related to any of Examples A1-A20, or portions or parts thereof.

Example Z07 includes a datagram, packet, frame, segment, protocol data unit (PDU), or message as described in or related to any of Examples A1-A20, or portions or parts thereof, or otherwise described in the present disclosure.

Example Z08 includes a signal encoded with data as described in or related to any of Examples A1-A20, or portions or parts thereof, or otherwise described in the present disclosure.

Example Z09 includes a signal encoded with a datagram, packet, frame, segment, protocol data unit (PDU), or message as described in or related to any of Examples A1-A20, or portions or parts thereof, or otherwise described in the present disclosure.

Example Z10 includes an electromagnetic signal carrying computer-readable instructions, wherein execution of the computer-readable instructions by one or more processors is to cause the one or more processors to perform the method, techniques, or process as described in or related to any of Examples A1-A20, or portions thereof.

Example Z11 includes a computer program comprising instructions, wherein execution of the program by a processing element is to cause the processing element to carry out the method, techniques, or process as described in or related to any of Examples A1-A20, or portions thereof.

Example Z12 includes a signal in a wireless network as shown and described herein.

Example Z13 includes a method of communicating in a wireless network as shown and described herein.

Example Z14 includes a system for providing wireless communication as shown and described herein.

Example Z15 includes a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. A non-transitory machine-readable storage medium storing instructions that correspond to a service consumer of a non-real-time (non-RT) radio access network intelligent controller (RIC) of a Service Management and Orchestration Framework (SMO FW), wherein the service consumer corresponds to one of a non-RT RIC application (rApp) of the non-RT RIC, or to an entity of a Non-RT RIC framework (Non-RT RIC FWK) of the non-RT RIC, the instructions to cause one or more processors, upon execution of the instructions, to perform operations including:
sending, to a service producer of the non-RT RIC, a training request for artificial intelligence/machine learning (AI/ML) training job;
sending, to the service producer, a query regarding a training status of the AI/ML training job;
sending, to the service producer, a cancel training request to cancel the AI/ML training job; and
receiving a notification from the service producer regarding the training status of the AI/ML training job.

2. The non-transitory machine-readable storage medium of claim 1, the operations further including:
receiving a request training response from the service producer in response to the training request, the request training response including an indication of acceptance of the training request;
receiving a query response from the service producer in response to the query, the query response including information regarding the training status of the AI/ML training job; and
receiving a request to cancel training response in response to cancel training request, cancel training request response including an indication of a cancellation of the AI/ML training job.

3. The non-transitory machine-readable storage medium of claim 2, wherein the request training response includes a training job identification (training job id) for the AI/ML training job.

4. The non-transitory machine-readable storage medium of claim 1, wherein the training status includes one of:
an indication that the AI/ML has been completed;
an indication that the AI/ML is in process;
an indication that the AI/ML is on hold;
an indication that the AI/ML has been aborted;
an indication that the AI/ML has timed out; or
an indication that the AI/ML has been cancelled.

5. The non-transitory machine-readable storage medium of claim 1, wherein the training request includes information regarding an rApp identification (rApp id), required training data for the AI/ML training job, model access details to retrieve a model for the AI/ML training job from a model repository, and a call-back uniform resource identifier (URI) to receive training status notifications for the AI/ML training job.

6. The non-transitory machine-readable storage medium of claim 5, wherein the training request further includes at least one of information about training criteria for the AI/ML training job, a maximum number of epochs for the AI/ML training job, or a maximum training time for the AI/ML training job.

7. The non-transitory machine-readable storage medium of claim 1, wherein the query includes an rApp identification (rApp id) and a training job identification (training job id) for the AI/ML training job.

8. The non-transitory machine-readable storage medium of claim 1, wherein the notification includes a training job identification (training job id) for the AI/ML training job, a training status of the AI/ML training job, and trained model access details to retrieve a trained model for the AI/ML training job from a model repository.

9. The non-transitory machine-readable storage medium of claim 1, wherein the service producer corresponds to AI/ML training functions of a Non-RT RIC framework of the Non-RT RIC.

10. The non-transitory machine-readable storage medium of claim 1, wherein the rApp corresponds to a first rApp of the non-RT RIC, and the service producer corresponds to a second rApp of the non-RT RIC.

11. The non-transitory machine-readable storage medium of claim 2, wherein:
sending the training request includes implementing a HyperText Transport Protocol (HTTP) POST method;
sending the query includes implementing an HTTP GET method; and
sending cancel training request the AI/ML training job includes implementing an HTTP DELETE method.

12. A non-transitory machine-readable storage medium storing instructions that correspond to a service producer of a non-real-time (non-RT) radio access network intelligent controller (RIC) of a Service Management and Orchestration Framework (SMO FW), the instructions to cause one or more processors, upon execution of the instructions, to perform operations including:
receiving, from a service consumer of the non-RT RIC, a training request for artificial intelligence/machine learning (AI/ML) training job, wherein the service consumer corresponds to one of a non-RT RIC application (rApp) of the non-RT RIC, or to an entity of a Non-RT RIC framework (Non-RT RIC FWK) of the non-RT RIC;
receiving, from the service consumer, a query regarding a training status of the AI/ML training job;
receiving, from the service consumer, a cancel training request to cancel the AI/ML training job; and
sending a notification to the service consumer regarding the training status of the AI/ML training job.

13. The non-transitory machine-readable storage medium of claim 12, the operations further including:
sending a request training response to the service consumer in response to the training request, the request training response including an indication of acceptance of the training request;
sending a query response to the service consumer in response to the query, the query response including information regarding the training status of the AI/ML training job; and
sending a request to cancel training response in response to cancel training request, cancel training request response including an indication of a cancellation of the AI/ML training job.

14. The non-transitory machine-readable storage medium of claim 13, wherein the service producer corresponds to AI/ML training functions of a Non-RT RIC framework of the Non-RT RIC.

15. The non-transitory machine-readable storage medium of claim 13, wherein the rApp corresponds to a first rApp of the non-RT RIC, and the service producer corresponds to a second rApp of the non-RT RIC.

16. The non-transitory machine-readable storage medium of claim 13, the operations further including, after receiving the cancel training request, terminating the AI/ML training.

17. The non-transitory machine-readable storage medium of claim 13, the operations further including sending the notification in response to completing the AI/ML training and to storing a model.

18. A method to be performed at a service producer of a non-real-time (non-RT) radio access network intelligent controller (RIC) of a Service Management and Orchestration Framework (SMO FW), the method including:
receiving, from a service consumer of the non-RT RIC, a training request for artificial intelligence/machine learning (AI/ML) training job, wherein the service consumer corresponds to one of a non-RT RIC application (rApp) of the non-RT RIC, or to an entity of a Non-RT RIC framework (Non-RT RIC FWK) of the non-RT RIC;
receiving, from the service consumer, a query regarding a training status of the AI/ML training job;
receiving, from the service consumer, a cancel training request to cancel the AI/ML training job; and
sending a notification to the service consumer regarding the training status of the AI/ML training job.

19. The method of claim 18, the method further including:
sending a request training response to the service consumer in response to the training request, the request training response including an indication of acceptance of the training request;
sending a query response to the service consumer in response to the query, the query response including information regarding the training status of the AI/ML training job; and
sending a request to cancel training response in response to cancel training request, cancel training request response including an indication of a cancellation of the AI/ML training job.

20. The method of claim 19, the method further including, after receiving the cancel training request, terminating the AI/ML training job.

21. An apparatus of a service consumer of a non-real-time (non-RT) radio access network intelligent controller (RIC) of a Service Management and Orchestration Framework (SMO FW), wherein the service consumer corresponds to one of a non-RT RIC application (rApp) of the non-RT RIC, or to an entity of a Non-RT RIC framework (Non-RT RIC FWK) of the non-RT RIC, the apparatus including:
means for sending, to a service producer of the non-RT RIC, a training request for artificial intelligence/machine learning (AI/ML) training job;
means for sending, to the service producer, a query regarding a training status of the AI/ML training job;
means for sending, to the service producer, a cancel training request to cancel the AI/ML training job; and
receiving a notification from the service producer regarding the training status of the AI/ML training job.

22. The apparatus of claim 21, further including:
means for receiving a request training response from the service producer in response to the training request, the request training response including an indication of acceptance of the training request;
means for receiving a query response from the service producer in response to the query, the query response including information regarding the training status of the AI/ML training job; and
means for receiving a request to cancel training response in response to cancel training request, cancel training request response including an indication of a cancellation of the AI/ML training job.

23. The apparatus of claim 22, wherein the request training response includes a training job identification (training job id) for the AI/ML training job.

24. The apparatus of claim 21, wherein the training status includes one of:
an indication that the AI/ML has been completed;
an indication that the AI/ML is in process;
an indication that the AI/ML is on hold;
an indication that the AI/ML has been aborted;
an indication that the AI/ML has timed out; or
an indication that the AI/ML has been cancelled.

25. The apparatus of claim 21, wherein the training request includes information regarding an rApp identification (rApp id), required training data for the AI/ML training job, model access details to retrieve a model for the AI/ML training job from a model repository, and a call-back uniform resource identifier (URI) to receive training status notifications for the AI/ML training job.
